(19) United States
(12) Patent Application Publication
(10) Pub. No.: US 2024/0080457 A1
(43) Pub. Date: Mar. 7, 2024

(54) INFORMATION PROCESSING APPARATUS AND INFORMATION PROCESSING METHOD

(71) Applicant: SONY SEMICONDUCTOR SOLUTIONS CORPORATION, KANAGAWA (JP)

(72) Inventor: JONGDAE KIM, KANAGAWA (JP)

(21) Appl. No.: 18/263,386

(22) PCT Filed: Jan. 5, 2022
(86) PCT No.: PCT/JP2022/000078

§ 371 Date: Jul. 28, 2023

(30) Foreign Application Priority Data
Feb. 8, 2021 (JP) 2021-017957

(51) Int. Cl. H04N 19/166; H04N 19/107; H04N 19/172

(52) U.S. Cl. CPC H04N 19/166; H04N 19/107; H04N 19/172

(57) ABSTRACT

The present disclosure relates to an information processing apparatus and an information processing method that enable suppression of an increase in time period in which image quality of a decoded image is degraded due to an error occurring on a reception side when encoded data of a video is transmitted.

Error information that is transmitted, via a second wireless channel, from a reception apparatus that receives encoded data of a video transmitted via a first wireless channel is acquired, the second wireless channel enabling transmission involving lower latency than the first wireless channel, and encoding of the video is controlled on the basis of the error information acquired. The present disclosure can be applied to, for example, an information processing apparatus, an encoding apparatus, a decoding apparatus, electronic equipment, an information processing method, a program, or the like.

### TECHNICAL FIELD

The present disclosure relates to an information processing apparatus and an information processing method, and in particular, to an information processing apparatus and an information processing method that enable suppression of an increase in time period in which image quality of a decoded image is degraded due to an error occurring on a reception side when encoded data of a video is transmitted.

### BACKGROUND ART

In recent years, the 3GPP (Third Generation Partnership Project) has studied and formulated specifications for a fifth-generation mobile communication system (hereinafter also referred to as 5G) that is a wireless communication system satisfying the provision IMT (International Mobile Telecommunications)-2020 specified by the International Telecommunication Union (for example, refer to NPL 1).

5G specifies use cases corresponding to applications. For example, 5G specifies a use case enabling a large amount of data to be transmitted (eMBB (enhance Mobile broadband)), a use case enabling data transmission with high reliability and low latency (URLLC (Ultra Reliable Low Latency Communication)), and the like.

### CITATION LIST

### Non Patent Literature

### [NPL 1]

“TR 21.916 V1.0.0 (2020 December),” 3rd Generation Partnership Project; Technical Specification Group Services and System Aspects; Release 16 Description; Summary of Rel-16 Work Items (Release 16)

### SUMMARY

### Technical Problem

However, a requirement for latency varies among the use cases. For example, in the case of a large-capacity use case (eMBB), the requirement for the latency in a wireless section is 4 ms. In contrast, in the case of a low-latency use case (URLLC), the requirement for the latency in the wireless section is 0.5 ms.

Consequently, in a case where the large-capacity use case (eMBB) is assumed as a wireless network for transmission of high-quality videos, network latency may delay error recovery.

In view of such circumstances, an object of the present disclosure is to enable suppression of an increase in time period in which the image quality of a decoded image is degraded due to an error occurring on a reception side when encoded data of a video is transmitted.

### Solution to Problem

An aspect of the present technology provides an information processing apparatus includes an error information acquisition section that acquires error information transmitted, via a second wireless channel, from a reception apparatus that receives encoded data of a video transmitted via a first wireless channel, the second wireless channel enabling transmission involving lower latency than the first wireless channel, and an encoding control section that controls encoding of the video on the basis of the error information acquired by the error information acquisition section.

The aspect of the present technology provides an information processing method including acquiring error information transmitted, via a second wireless channel, from a reception apparatus that receives encoded data of a video transmitted via a first wireless channel, the second wireless channel enabling transmission involving lower latency than the first wireless channel, and controlling encoding of the video on the basis of the error information acquired.

Another aspect of the present technology provides an information processing apparatus including a data reception section that receives encoded data of a video transmitted via a first wireless channel, and an error information transmission section that transmits error information indicating an error related to the encoded data received by the data reception section, to a transmission source of the encoded data via a second wireless channel enabling transmission involving lower latency than the first wireless channel.

The other aspect of the present technology provides an information processing method including receiving encoded data of a video transmitted via a first wireless channel, and transmitting error information indicating an error related to the encoded data, to a transmission source of the encoded data via a second wireless channel enabling transmission involving lower latency than the first wireless channel.

In the information processing apparatus and the information processing method according to the aspect of the present technology, the error information that is transmitted, via the second wireless channel, from the reception apparatus that receives the encoded data of the video transmitted via the first wireless channel is acquired, the second wireless channel enabling transmission involving lower latency than the first wireless channel, and encoding of the video is controlled on the basis of the error information acquired.

In the information processing apparatus and the information processing method according to the other aspect of the present technology, the encoded data of the video transmitted via the first wireless channel is received, and the error information indicating the error related to the encoded data is transmitted to the transmission source of the encoded data via the second wireless channel enabling transmission involving lower latency than the first wireless channel.

### BRIEF DESCRIPTION OF DRAWINGS

FIG. 1 is a diagram for describing an example of an image transmission system.

FIG. 2 is a diagram for describing an example of latency involved when an error is handled.

FIG. 3 is a diagram depicting a main configuration example of an image transmission system.

FIG. 4 is a block diagram depicting a main configuration example of an image encoding apparatus.

FIG. 5 is a block diagram depicting a main configuration example of an encoding section.

FIG. 6 is a block diagram depicting a main configuration example of an image decoding apparatus.

FIG. 7 is a block diagram depicting a main configuration example of a decoding section.

FIG. 8 is a flowchart for describing an example of a flow of image encoding processing.

FIG. 9 is a flowchart for describing an example of a flow of image decoding processing.

FIG. 10 is a diagram for describing an example of latency involved when an error is handled.

FIG. 11 is a diagram for describing an example of video encoding.

FIG. 12 is a diagram for describing an example of an intra stripe.

FIG. 13 is a diagram for describing an example of code amount.

FIG. 14 is a diagram for describing an example of encoding control.

FIG. 15 is a flowchart for describing an example of a flow of encoding control processing.

FIG. 16 is a diagram for describing an example of encoding control.

FIG. 17 is a flowchart for describing an example of a flow of encoding control processing.

FIG. 18 is a diagram depicting a main configuration example of the image transmission system.

FIG. 19 is a diagram depicting a main configuration example of the image transmission system.

FIG. 20 is a diagram depicting a main configuration example of the image transmission system.

FIG. 21 is a block diagram depicting a main configuration example of a computer.

### DESCRIPTION OF EMBODIMENTS

Modes for implementing the present disclosure (hereinafter referred to as embodiments) will be described below. Note that the description will be given in the following order. 1. Latency Involved When Error Is Handled 2. First Embodiment (Image Transmission System) 3. Second Embodiment (Encoding Control 1) 4. Third Embodiment (Encoding Control 2) 5. Fourth Embodiment (Another Example of Image Transmission System)
6. Supplementary Note

### 1. Latency Involved when Error is Handled

### Documents, Etc., Supporting Technical Contents and Technical Terms

The scope disclosed by the present technology includes not only contents described in the embodiments but also contents described in Non Patent Literature and Patent Literature listed below and known at the time of filing of the present disclosure.
NPL 1: (listed above)
NPL 2: Recommendation ITU-T H.264 (April 2017) “Advanced video coding for generic audiovisual services,” April 2017
NPL 3: Recommendation ITU-T H.265 (February 18) “High efficiency video coding,” February 2018
NPL 4: Benjamin Bross, Jianle Chen, Shan Liu, Ye-Kui Wang, “Versatile Video Coding (Draft 7),” JVET-P2001-vE, Joint Video Experts Team (JVET) of ITU-T SG 16 WP 3 and ISO/IEC JTC 1/SC 29/WG 11 16th Meeting: Geneva, CH, 1-11 Oct. 2019
NPL 5: Satoshi NAGATA, Kazuaki TAKEDA, Hiromasa UMEDA, Hideaki TAKAHASHI, Kenichiro AOYAGI, “3GPP Release 15 Standardization Technology,” https://www.nttdocomo.co.jp/binary/pdf/corporate/technology/rd/technical_journal/bn/vol26_3/vol26_3_007jp.pdf
PTL 1: JP 2010-062946A

In other words, grounds for determining support requirements also include the contents described in Non Patent Literature and Patent Literature listed above and contents of other documents referred to in Non Patent Literature and Patent Literature listed above.

In other words, the contents described in Non Patent Literature and Patent Literature listed above also constitute the grounds for determining the support requirements. For example, even in a case where examples of the present disclosure contain no direct descriptions of a Quad-Tree Block Structure and a QTBT (Quad Tree Plus Binary Tree) Block Structure described in Non Patent Literature listed above, the Quad-Tree Block Structure and the QTBT Block Structure are intended to be within the scope of disclosure of the present technology and to satisfy the support requirements of claims. In addition, for example, also for the technical terms such as parsing, syntax, and semantics, even in a case where the examples of the present disclosure contain no direct descriptions of the technical terms, the technical terms are within the scope of disclosure of the present technology and satisfy the support requirements of claims.

In addition, the “block” as used herein as a subregion or a processing unit of an image (picture) (this block does not indicate a processing section) indicates any subregion in a picture unless otherwise noted, and there are no limitations on the size, shape, characteristics, and the like of the block. For example, the “block” includes any subregion (processing unit) such as a TB (Transform Block), a TU (Transform Unit), a PB (Prediction Block), a PU (Prediction Unit), an SCU (Smallest Coding Unit), a CU (Coding Unit), an LCU (Largest Coding Unit), a CTB (Coding Tree Block), a CTU (Coding Tree Unit), a subblock, a macroblock, a tile, or a slice.

In addition, in specification of the size of such a block, the block size may not only be directly specified but also be indirectly specified. For example, identification information identifying the size may be used to specify the block size. In addition, for example, the block size may be specified by a ratio to or a difference from the size of a block as a reference (for example, an LCU or an SCU). For example, in a case where information that specifies the block size as a syntax element or the like is transmitted, as this information, information indirectly specifying the size may be used as described above. Such specification enables a reduction in amount of the information, allowing encoding efficiency to be improved. In addition, the specification of the block size includes specification of the range of the block size (for example, specification of the acceptable range of the block size and the like).

### Latency Involved in Handling of Error in Image Transmission System

In the related art, various systems have been developed as image transmission systems that transmit image data. For example, there has been developed a system that transmits videos and the like by using wireless communication. In general, image data such as a video has a large data size, and thus, there has been designed a method in which the image data is encoded (compressed) for transmission.

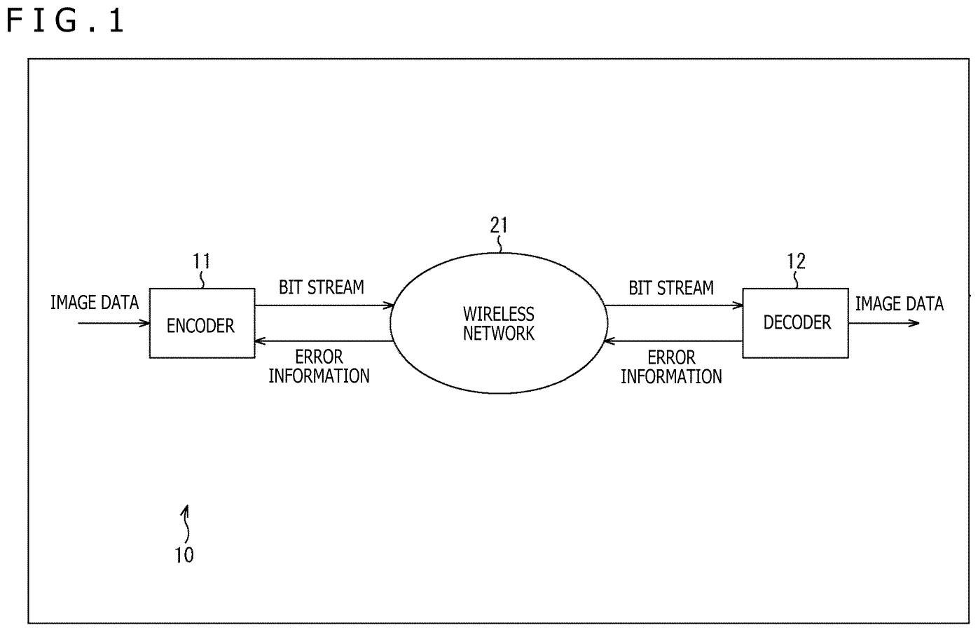

For example, an image transmission system 10 depicted in FIG. 1 includes an encoder 11 on a transmission side (in other words, on a transmission source side) and a decoder 12 on a reception side (in other words, on a transmission destination side). The encoder 11 encodes the image data. Then, encoded data of the image data (bit stream) is transmitted to the decoder 12 via a wireless network 21. The decoder 12 decodes the bit stream into image data (decoded image), and outputs the image data.

In the image transmission system 10 as described above, an error may occur in reception or decoding of the bit stream. In that case, the decoder 12 fails to obtain a decoded image for the bit stream. In a case where the transmitted image data is a video and frames subsequent to the frame in which an error has occurred are inter-coded, the error may propagate to the subsequent frames, and decoded images of these subsequent frames may continuously fail to be obtained.

Accordingly, for example, control of transmission of the bit stream (in other words, encoding of the image data) has been designed, the control being performed in response to occurrence of an error on the reception side. For example, in a case where the decoder 12 fails in reception or decoding, error information indicating the error is transmitted to the encoder 11 via a wireless network 21. Upon obtaining the error information, the encoder 11 performs encoding in such a manner as to prevent the error from propagating to the subsequent frames.

Such control allows the decoder 12 to obtain a decoded image earlier.

In recent years, for example, as disclosed in NPL 1, the 3GPP (Third Generation Partnership Project) has studied and formulated specifications for a fifth-generation mobile communication system (hereinafter also referred to as 5G) that is a wireless communication system satisfying the provision IMT (International Mobile Telecommunications)-2020 specified by the International Telecommunication Union.

5G specifies use cases corresponding to applications. For example, 5G specifies a use case enabling a large amount of data to be transmitted (eMBB (enhance Mobile broadband)), a use case enabling data transmission with high reliability and low latency (URLLC (Ultra Reliable Low Latency Communication)), and the like. For example, by assuming a large-capacity use case (eMBB) as a wireless network, high-quality videos can be transmitted. For example, in the case of the image transmission system 10 as in an example of FIG. 1, the large-capacity use case (eMBB) is intended to be applied as the wireless network 21. In this case, the wireless network 21 for the large-capacity use case (eMBB) is used as an intermediary not only for transmission of a bit stream of a video from the encoder 11 to the decoder 12 but also for transmission of error information from the decoder 12 to the encoder 11.

However, a requirement for latency varies among the use cases. For example, in the case of the large-capacity use case (eMBB), the requirement for the latency in a wireless section is 4 ms. In contrast, in the case of a low-latency use case (URLLC), the requirement for the latency in the wireless section is 0.5 ms.

Consequently, in a case where, as the wireless network 21 in the image transmission system 10 in FIG. 1, the large-capacity use case (eMBB) is applied to transmit a high-quality video, then compared to the low-latency use case (URLLC), the large-capacity use case (eMBB) may also increase network latency in transmission of error information having a smaller data amount than the bit stream of the video. In other words, timing for encoding control based on the error information may be delayed. Delayed timing for encoding control may increase the amount of time taken until the decoder 12 can obtain a decoded image.

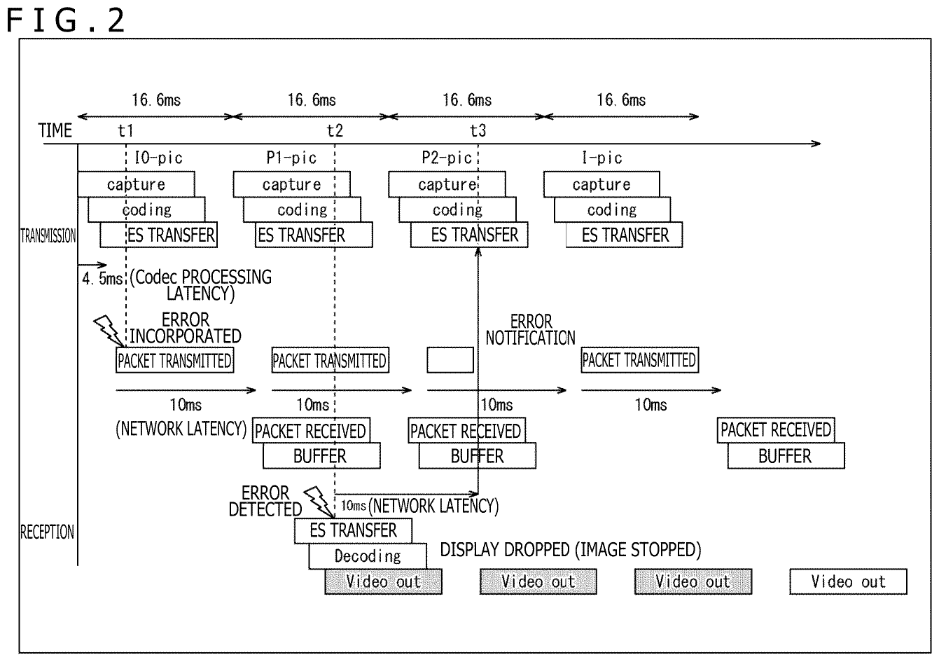

For example, as depicted in FIG. 2, each frame is assumed to be encoded on the transmission side, and resultant encoded data is assumed to be sequentially transmitted from the transmission side to the reception side and to be decoded on the reception side. For example, an error is assumed to be incorporated into a packet at time t1, and to be detected on the reception side at time t2. In a case where notification regarding the error is made via the wireless network 21 for the large-capacity use case (eMBB) as in the example of FIG. 1, the transmission side is notified of the error at time t3 (for example, 10 ms later) due to network latency or the like. Consequently, encoding control based on the error is performed at time t3 on a frame next to a frame P2 to be processed. Therefore, in an example of FIG. 2, no decoded image can be obtained for three frames (the decoded image is lost). A failure to obtain frames (decoded image) degrades the image quality of the video (decoded video).

As described above, in a case where the bit stream and error information are transmitted via the wireless network 21 for the large-capacity use case (eMBB), the time period in which the image quality of the decoded image is degraded due to an error occurring on the reception side may be increased.

Note that, in a case where the low-latency use case (URLLC) is applied as the wireless network 21 in the image transmission system 10 in FIG. 1 in order to reduce the latency, an insufficient transmission data rate may make transmission of the bit stream of the video difficult.

### Construction of Network for Error Information Transmission

Accordingly, the error information is transmitted via wireless communication that is different from a wireless channel used to transmit the bit stream and that involves lower latency than the wireless channel used to transmit the bit stream.

For example, an information processing method includes acquiring error information received from a reception apparatus that receives encoded data of a video transmitted via a first wireless channel, the error information being transmitted via a second wireless channel enabling transmission involving lower latency than the first wireless channel, and controlling encoding of the video on the basis of the error information acquired.

For example, an information processing apparatus includes an error information acquisition section that acquires error information received from a reception apparatus that receives encoded data of a video transmitted via a first wireless channel, the error information being transmitted via a second wireless channel enabling transmission involving lower latency than the first wireless channel, and an encoding control section that controls encoding of the video on the basis of the error information acquired by the error information acquisition section.

In addition, for example, an information processing method includes receiving encoded data of a video transmitted via a first wireless channel and transmitting error information indicating an error related to the encoded data, to a transmission source of the encoded data via a second wireless channel enabling transmission involving lower latency than the first wireless channel.

For example, an information processing apparatus includes a data reception section that receives encoded data of a video transmitted via a first wireless channel and an error information transmission section that transmits error information indicating an error related to the encoded data received by the data reception section, to a transmission source of the encoded data via a second wireless channel enabling transmission involving lower latency than the first wireless channel.

Such control enables suppression of an increase in time period in which the image quality of a decoded image is degraded due to an error occurring on the reception side when encoded data of a video is transmitted.

### 2. First Embodiment

### Image Transmission System

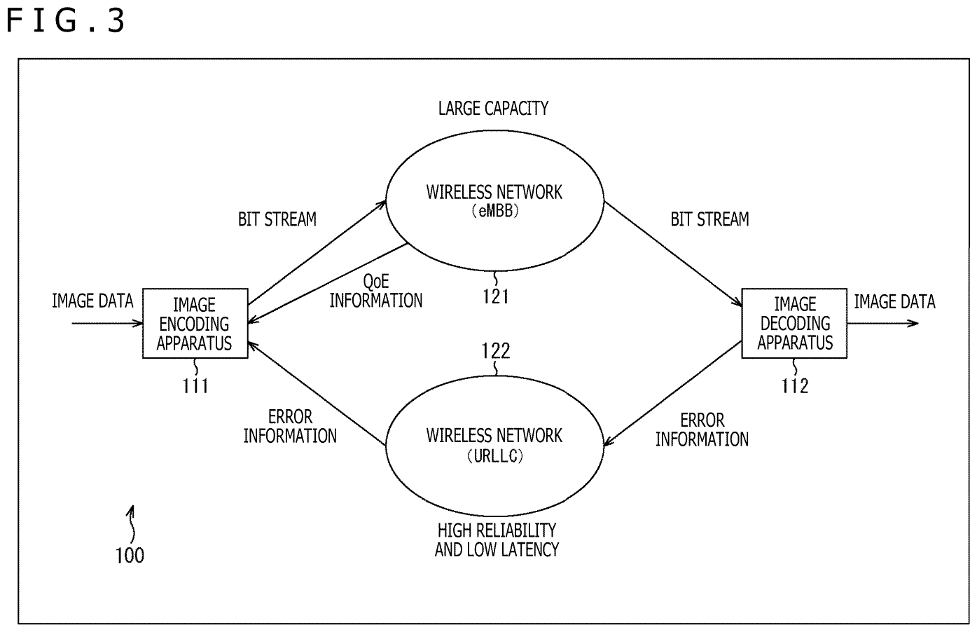

FIG. 3 is a diagram depicting a main configuration example of an image transmission system to which the present technology is applied. An image transmission system 100 depicted in FIG. 3 is a system that transmits videos. As depicted in FIG. 3, the image transmission system 100 includes an image encoding apparatus 111 and an image decoding apparatus 112. The image encoding apparatus 111 and the image decoding apparatus 112 are communicably connected via a wireless network 121. In addition, the image encoding apparatus 111 and the image decoding apparatus 112 are communicably connected via a wireless network 122.

The image encoding apparatus 111 acquires image data of a transmitted video, encodes the image data to generate encoded data of the image data (bit stream). The image encoding apparatus 111 transmits the bit stream to the image decoding apparatus 112 via the wireless network 121. The image decoding apparatus 112 receives and decodes the bit stream. The image decoding apparatus 112 outputs image data of a decoded image (decoded video) obtained by the decoding.

The wireless network 121 is a wireless channel enabling data transmission of a large capacity (having a high transmission data rate) compared to the wireless network 122. The wireless network 121 may have any specifications, but requires a transmission data rate at which a bit stream of image data can be transmitted.

In addition, in a case where an error occurs in, for example, reception or decoding of the bit stream (in other words, in a case where no decoded image is obtained), the image decoding apparatus 112 transmits error information indicating the error, to the image encoding apparatus 111 via the wireless network 122. The image encoding apparatus 111 receives the error information. The image encoding apparatus 111 controls encoding of the video on the basis of the received error information and the like. For example, the image encoding apparatus 111 performs encoding in such a manner as to prevent the error from propagating to the subsequent frames.

The wireless network 122 is a wireless channel enabling data transmission with high reliability and low latency compared to the wireless network 121. The wireless network 122 may have any specifications, but has a requirement for latency shorter than that in the wireless network 121.

The wireless network 121 and the wireless network 122 are wireless channels having frequency bands (channels) different from each other. For example, the large-capacity use case (eMBB) of 5G may be applied as the wireless network 121. For example, the low-latency use case (URLLC) of 5G may be applied as the wireless network 122. In the description below, the wireless network 121 is assumed to be a wireless channel for the large-capacity use case (eMBB) of 5G, and the wireless network 122 is assumed to be a wireless channel for the low-latency use case (URLLC) of 5G.

The image encoding apparatus 111 can also monitor the state of the wireless network 121 to obtain, for the wireless network 121, QoE (Quality of Experience) information corresponding to subjective evaluation. The image encoding apparatus 111 can control encoding of a video also on the basis of the QoE information. The QoE information may be any information. For example, as in a method described in NPL 5, the QoE information may include information such as wireless disconnection or a handover failure during communication which is collected from a terminal with use of a mechanism of MDT (Minimization of Drive Test).

Note that FIG. 3 depicts one image encoding apparatus 111 and one image decoding apparatus 112 but that the image encoding apparatus 111 and the image decoding apparatus 112 may be provided in any number, and, for example, multiple image encoding apparatuses 111 and multiple image decoding apparatuses 112 may be provided. In other words, the image transmission system 100 may include the image encoding apparatus 111 and the image decoding apparatus 112 in any number. In addition, the image transmission system 100 may include an apparatus other than the image encoding apparatus 111 and the image decoding apparatus 112. Further, the image transmission system 100 may include a wireless channel other than the wireless network 121 and the wireless network 122.

### Image Encoding Apparatus

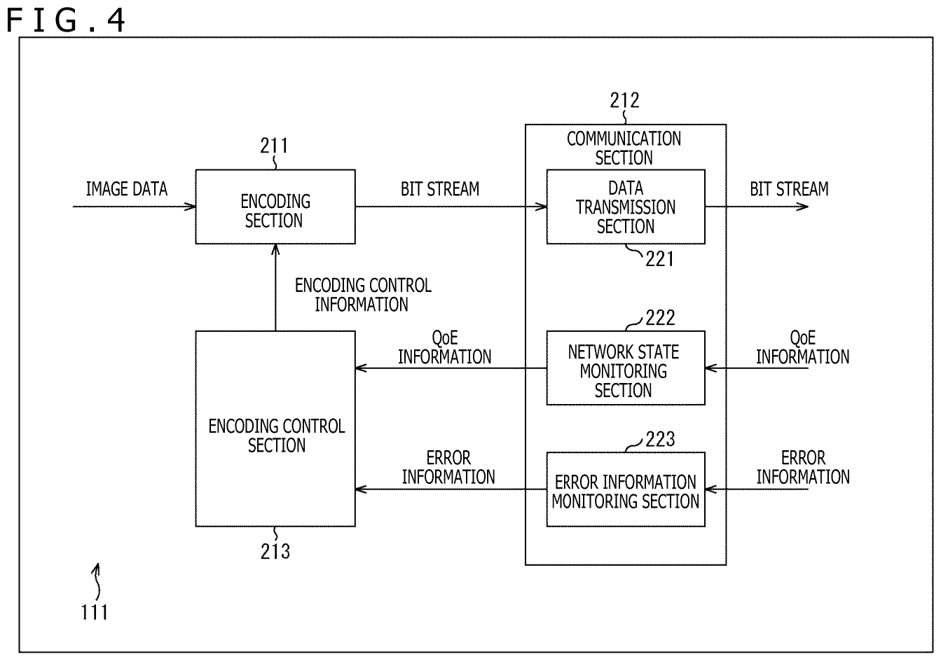

FIG. 4 is a block diagram depicting a main configuration example of the image encoding apparatus 111 in FIG. 3.

Note that FIG. 4 depicts main processing sections, data flows, and the like and that FIG. 4 does not necessarily depict all processing sections, data flows, and the like. In other words, in the image encoding apparatus 111, a processing section that is not depicted as a block in FIG. 4 may be present, and a data flow that is not depicted as an arrow or the like in FIG. 4 may be present.

As depicted in FIG. 4, the image encoding apparatus 111 includes an encoding section 211, a communication section 212, and an encoding control section 213. The communication section 212 includes a data transmission section 221, a network state monitoring section 222, and an error information monitoring section 223.

The encoding section 211 encodes image data input to the image encoding apparatus 111 (video to be transmitted) to generate encoded data (bit stream) of the image data. In this case, any encoding method may be used. For example, applicable encoding methods may include AVC (Advanced Video Coding) described in NPL 2 listed above, HEVC (High Efficiency Video Coding) described in NPL 3 listed above, or VVC (Versatile Video Coding) described in NPL 4 listed above. Needless to say, any other encoding method is applicable. The encoding section 211 feeds the bit stream generated to the communication section 212 (data transmission section 221 of the communication section 212).

The communication section 212 executes processing related to communication.

The data transmission section 221 acquires a bit stream fed from the encoding section 211. The data transmission section 221 transmits the bit stream acquired to the image decoding apparatus 112 via the wireless network 121 (eMBB).

The network state monitoring section 222 monitors the state of the wireless network 121 to obtain QoE information regarding the network. The network state monitoring section 222 feeds the QoE information obtained to the encoding control section 213.

The error information monitoring section 223 monitors error information transmitted from the image decoding apparatus 112 via the wireless network 122 (URLLC). In a case where error information is transmitted from the image decoding apparatus 112, the error information monitoring section 223 receives the error information via the wireless network 122. In other words, the error information monitoring section 223 acquires the error information from the image decoding apparatus 112 that receives encoded data of a video transmitted via the wireless network 121, the error information being transmitted via the wireless network 122 enabling transmission involving lower latency than the wireless network 121. The error information monitoring section 223 feeds the received error information to the encoding control section 213.

The encoding control section 213 controls encoding processing executed by the encoding section 211. By feeding the encoding section 211 with encoding control information specifying the encoding method, parameters, and the like, the encoding control section 213 controls encoding processing executed by the encoding section 211.

For example, the encoding control section 213 acquires the error information fed from the error information monitoring section 223 and controls the encoding section 211 on the basis of the error information. For example, in a case where the encoding control section 213 acquires the error information, the encoding control section 213 causes the encoding section 211 to execute encoding processing in such a manner as to prevent an error indicated by the error information from propagating to the subsequent frames.

In addition, the encoding control section 213 acquires the QoE information fed from the network state monitoring section 222, and controls the encoding section 211 on the basis of the QoE information. For example, the encoding control section 213 causes the encoding section 211 to execute the encoding processing in such a manner as to improve a communication status of the wireless network 121.

### Encoding Section

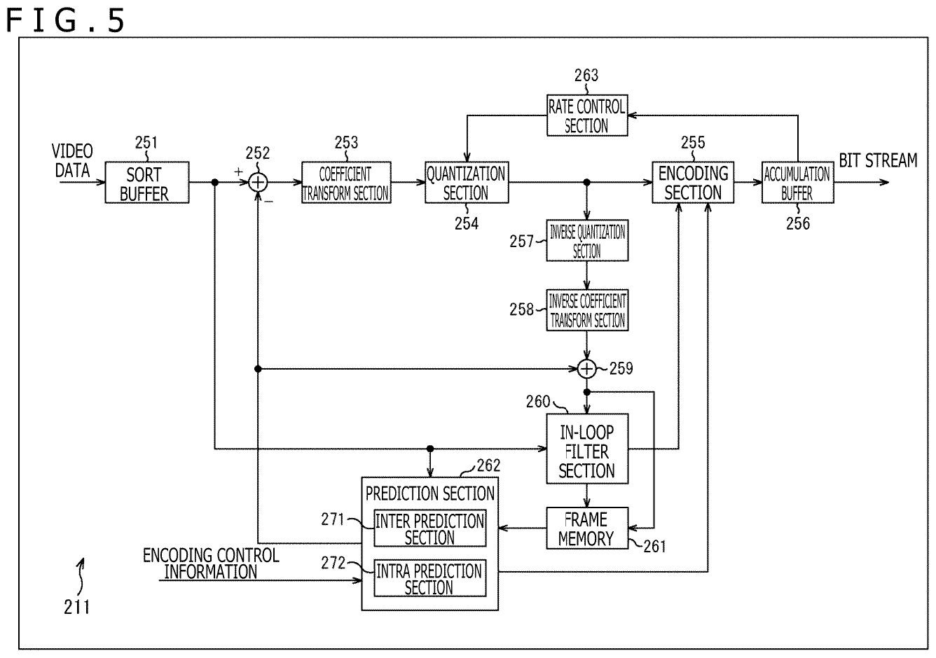

FIG. 5 is a block diagram depicting a configuration example of the encoding section 211 in FIG. 4.

Note that FIG. 5 depicts main processing sections, data flows, and the like and that FIG. 5 does not necessarily depict all processing sections, data flows, and the like. In other words, in the encoding section 211, a processing section that is not depicted as a block in FIG. 5 may be present, and a data flow that is not depicted as an arrow or the like in FIG. 5 may be present.

As depicted in FIG. 5, the encoding section 211 includes a sort buffer 251, a calculation section 252, a coefficient transform section 253, a quantization section 254, an encoding section 255, and an accumulation buffer 256. In addition, the encoding section 211 includes an inverse quantization section 257, an inverse coefficient transform section 258, a calculation section 259, an in-loop filter section 260, and a frame memory 261. Further, the encoding section 211 includes a prediction section 262 and a rate control section 263. The prediction section 262 includes an inter prediction section 271 and an intra prediction section 272.

Frames (input images) of a video are input to the encoding section 211 in order of reproduction (in order of display). The sort buffer 251 acquires and holds (stores) the input images in order of reproduction (in order of display). The sort buffer 251 sorts the input images in order of encoding (in order of decoding) and divides the input images into blocks as processing units. The sort buffer 251 feeds each of the processed input images to the calculation section 252.

The calculation section 252 subtracts a predicted image fed from the prediction section 262 from an image corresponding to a block as a processing unit, the block being fed from the sort buffer 251, to derive residual data, and feeds the residual data to the coefficient transform section 253.

The coefficient transform section 253 acquires the residual data fed from the calculation section 252. In addition, the coefficient transform section 253 uses a predetermined method to perform coefficient transform on the residual data to derive transformed coefficient data. Any method of coefficient transform processing may be used. For example, the method may be orthogonal transform. The coefficient transform section 253 feeds the derived transformed coefficient data to the quantization section 254.

The quantization section 254 acquires the transformed coefficient data fed from the coefficient transform section 253. In addition, the quantization section 254 quantizes the transformed coefficient data to derive quantized coefficient data. At this time, the quantization section 254 performs quantization at a rate specified by the rate control section 263.

The quantization section 254 feeds the derived quantized coefficient data to the encoding section 255 and the inverse quantization section 257.

The encoding section 255 acquires the quantized coefficient data fed from the quantization section 254. In addition, the encoding section 255 acquires information related to a filter such as a filter coefficient, the information being fed from the in-loop filter section 260. Further, the encoding section 255 acquires information related to an optimum prediction mode fed from the prediction section 262.

The encoding section 255 entropy-codes (lossless-codes) the information to generate a bit string (encoded data) and multiplex the bit string. Any method of entropy coding may be used. For example, the encoding section 255 can apply a CABAC (Context-based Adaptive Binary Arithmetic Code) as the entropy coding. In addition, the encoding section 255 can apply a CAVLC (Context-based Adaptive Variable Length Code) as the entropy coding. Needless to say, any other encoding method is applicable.

The encoding section 255 feeds the accumulation buffer 256 with the encoded data derived as described above.

The accumulation buffer 256 temporarily holds the encoded data obtained by the encoding section 255. At a predetermined timing, the accumulation buffer 256 feeds the held encoded data to the data transmission section 221, for example, as a bit stream or the like.

The inverse quantization section 257 acquires the quantized coefficient data fed from the quantization section 254. The inverse quantization section 257 inversely quantizes the quantized coefficient data to derive transformed coefficient data. The inverse quantization processing is inverse processing of the quantization processing executed in the quantization section 254. The inverse quantization section 257 feeds the derived transformed coefficient data to the inverse coefficient transform section 258.

The inverse coefficient transform section 258 acquires the transformed coefficient data fed from the inverse quantization section 257. The inverse coefficient transform section 258 uses a predetermined method to perform inverse coefficient transform on the transformed coefficient data to derive residual data. The inverse coefficient transform processing is inverse processing of the coefficient transform processing executed in the coefficient transform section 253. For example, in a case where the coefficient transform section 253 executes orthogonal transform processing on the residual data, the inverse coefficient transform section 258 executes, on the transformed coefficient data, inverse orthogonal transform processing that is inverse processing of the orthogonal transform processing. The inverse coefficient transform section 258 feeds the derived residual data to the calculation section 259.

The calculation section 259 acquires the residual data fed from the inverse coefficient transform section 258 and the predicted image fed from the prediction section 262. The calculation section 259 adds the residual data and the predicted image corresponding to the residual data to derive a local decoded image. The calculation section 259 feeds the derived local decoded image to the in-loop filter section 260 and the frame memory 261.

The in-loop filter section 260 acquires the local decoded image fed from the calculation section 259. In addition, the in-loop filter section 260 acquires the input image (original image) fed from the sort buffer 251. Note that any information may be input to the in-loop filter section 260 and that information other than the above-described pieces of information may be input to the in-loop filter section 260. For example, as necessary, the in-loop filter section 260 may receive, as input, information such as a prediction mode, motion information, a code amount target value, a quantization parameter qP, a picture type, or a block (CU, CTU, or the like).

The in-loop filter section 260 executes filter processing on the local decoded image as appropriate. The in-loop filter section 260 uses the input image (original image) and other input information for filter processing as necessary.

For example, the in-loop filter section 260 may apply a bilateral filter as the filter processing of the in-loop filter section 260. For example, the in-loop filter section 260 can apply a deblocking filter (DBF) as the filter processing of the in-loop filter section 260. For example, the in-loop filter section 260 can apply an adaptive offset filter (SAO (Sample Adaptive Offset)) as the filter processing of the in-loop filter section 260. For example, the in-loop filter section 260 can apply an adaptive loop filter (ALP) as the filter processing of the in-loop filter section 260. In addition, the in-loop filter section 260 can apply multiple filters of these filters in combination as filter processing. Note that which of the filters is applied and in which order the filters are applied may freely be determined and can be selected as appropriate. For example, the in-loop filter section 260 applies, as filter processing, the bilateral filter, the deblocking filter, the adaptive offset filter, and the adaptive loop filter in this order.

Needless to say, the in-loop filter section 260 may execute any filter processing, and the filter processing is not limited to the above-described examples. For example, the in-loop filter section 260 may apply a Wiener filter or the like.

The in-loop filter section 260 feeds the frame memory 261 with the local decoded image that has been subjected to the filter processing. Note that, for example, in a case where information related to the filter such as the filter coefficient is transmitted to a decoding side, the in-loop filter section 260 feeds the encoding section 255 with the information related to the filter.

The frame memory 261 executes processing related to storage of data regarding the image. For example, the frame memory 261 acquires the local decoded image fed from the calculation section 259 and the local decoded image that has been subjected to the filter processing, which is fed from the in-loop filter section 260, and holds (stores) the local decoded images. In addition, the frame memory 261 uses the local decoded images to reconstruct a decoded image on a per picture basis and holds the decoded image (stores the decoded image in a buffer in the frame memory 261). In response to a request from the prediction section 262, the frame memory 261 feeds the decoded image (or a part of the decoded image) to the prediction section 262.

The prediction section 262 executes processing related to generation of a predicted image. For example, the prediction section 262 acquires the input image (original image) fed from the sort buffer 251. For example, the prediction section 262 acquires the decoded image (or a part of the decoded image) read from the frame memory 261.

The inter prediction section 271 of the prediction section 262 references the decoded image of another frame as a reference image to perform inter prediction and motion compensation and generate a predicted image. In addition, the intra prediction section 272 of the prediction section 262 references the decoded image of the current frame as a reference image to perform intra prediction and generate a predicted image.

The prediction section 262 evaluates the predicted image generated in each prediction mode, and selects the optimum prediction mode on the basis of the result of the evaluation. Then, the prediction section 262 feeds the calculation section 252 and the calculation section 259 with the predicted image generated in the optimum prediction mode. In addition, as necessary, the prediction section 262 feeds the encoding section 255 with information related to the optimum prediction mode selected by the above-described processing.

Note that the prediction section 262 (the inter prediction section 271 and the intra prediction section 272 of the prediction section 262) can also perform prediction according to control of the encoding control section 213. For example, the prediction section 262 can acquire encoding control information fed from the encoding control section 213 and perform intra prediction or inter prediction according to the encoding control information.

On the basis of the code amount of encoded data accumulated in the accumulation buffer 256, the rate control section 263 controls the rate of the quantization operation of the quantization section 254 in such a manner as to prevent overflow or underflow.

### Image Decoding Apparatus

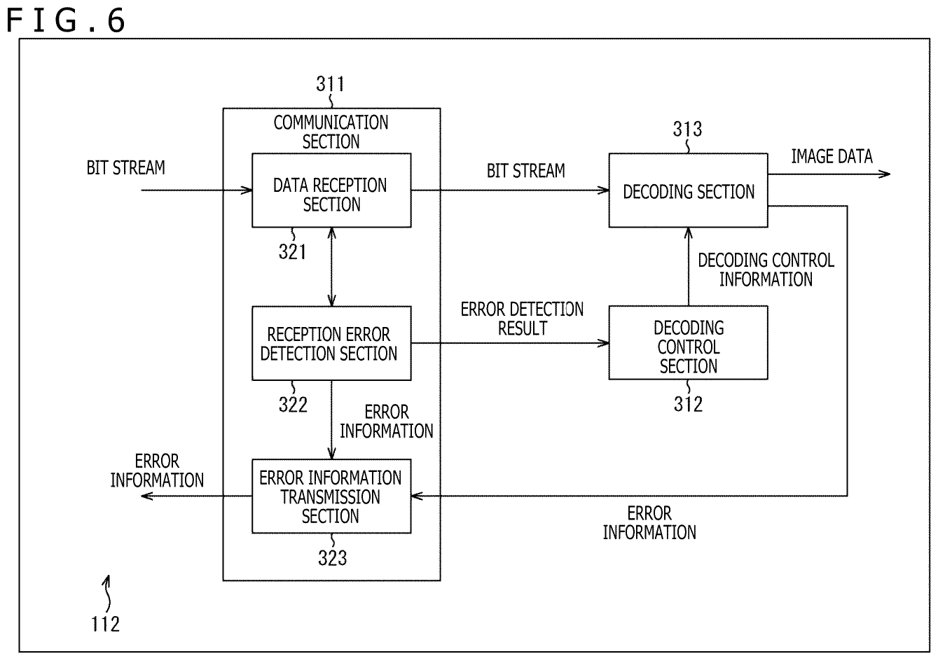

FIG. 6 is a block diagram depicting a main configuration example of the image decoding apparatus 112 in FIG. 3.

Note that FIG. 6 depicts main processing sections, data flows, and the like and that FIG. 6 does not necessarily depict all processing sections, data flows, and the like. In other words, in the image decoding apparatus 112, a processing section that is not depicted as a block in FIG. 6 may be present, and a data flow that is not depicted as an arrow or the like in FIG. 6 may be present.

As depicted in FIG. 6, the image decoding apparatus 112 includes a communication section 311, a decoding control section 312, and a decoding section 313. The communication section 311 includes a data reception section 321, a reception error detection section 322, and an error information transmission section 323.

The communication section 311 executes processing related to communication.

The data reception section 321 receives a bit stream transmitted from the image encoding apparatus 111 via the wireless network 121 (eMBB). The data reception section 321 feeds the received bit stream to the decoding section 313.

The reception error detection section 322 monitors a reception status of the data reception section 321 to detect an error occurring in the data reception section 321 (reception error). In a case where the reception error detection section 322 detects a reception error, the reception error detection section 322 feeds the error information transmission section 323 with error information indicating the reception error. In addition, the reception error detection section 322 feeds the result of error detection (information indicating whether or not a reception error has been detected, for example) to the decoding control section 312.

The error information transmission section 323 transmits the error information to the image encoding apparatus 111 via the wireless network 122 (URLLC). The error information is transmitted to the image encoding apparatus 111 via the wireless network 122 (URLLC) and received by the error information monitoring section 223.

In other words, the error information transmission section 323 transmits the error information which is information indicating the error related to the encoded data received by the data reception section 321, to the transmission source of the encoded data via the wireless network 122 enabling transmission involving lower latency than the wireless network 121.

The error information transmission section 323 acquires the error information indicating the reception error, which is fed from the reception error detection section 322. In addition, the error information transmission section 323 acquires error information indicating a decoding error, which is fed from the decoding section 313. The error information transmission section 323 transmits the error information acquired to the image encoding apparatus 111.

In other words, the error information transmitted by the error information transmission section 323 can include information indicating a possible error occurring upon reception of the encoded data. In addition, the error information transmitted by the error information transmission section 323 can include information indicating a possible error occurring upon decoding of the encoded data. Needless to say, the error information transmitted by the error information transmission section 323 may include both pieces of the information described above or information indicating another error.

The decoding control section 312 controls decoding processing executed by the decoding section 313. For example, by feeding the decoding section 313 with decoding control information specifying the decoding method, parameters, and the like, the decoding control section 312 controls decoding processing executed by the decoding section 313.

For example, the decoding control section 312 acquires an error detection result fed from the reception error detection section 322, and controls the encoding section 211 on the basis of the error detection result.

The decoding section 313 acquires the bit stream fed from the data reception section 321. The decoding section 313 decodes the bit stream to generate image data of a decoded image (decoded video to be transmitted). The decoding section 313 outputs the image data to the outside of the image decoding apparatus 112. Note that the decoding section 313 can execute this decoding processing according to control of the decoding control section 312. In addition, in a case where an error (decoding error) occurs in the decoding processing, the decoding section 313 feeds the error information transmission section 323 with error information indicating the decoding error.

### Decoding Section

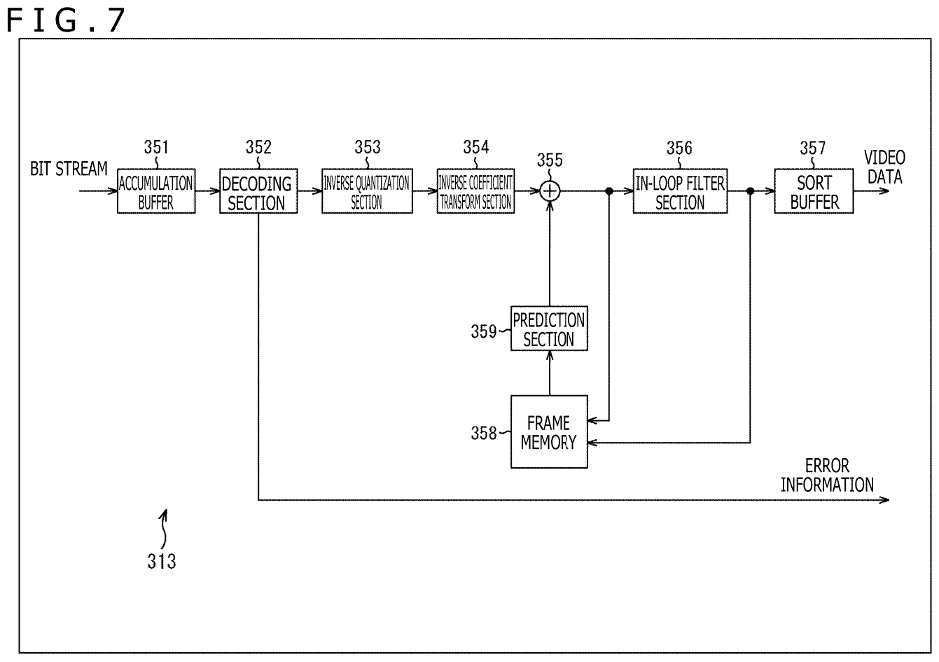

FIG. 7 is a block diagram depicting a main configuration example of the decoding section 313 in FIG. 6.

Note that FIG. 7 depicts main processing sections, data flows, and the like and that FIG. 7 does not necessarily depict all processing sections, data flows, and the like. In other words, in the decoding section 313, a processing section that is not depicted as a block in FIG. 7 may be present, and a data flow that is not depicted as an arrow or the like in FIG. 7 may be present.

As depicted in FIG. 7, the decoding section 313 includes an accumulation buffer 351, a decoding section 352, an inverse quantization section 353, an inverse coefficient transform section 354, a calculation section 355, an in-loop filter section 356, a sort buffer 357, a frame memory 358, and a prediction section 359.

The accumulation buffer 351 acquires and holds (stores) the bit stream fed from the data reception section 321. At a predetermined timing or in a case where a predetermined condition is met, for example, the accumulation buffer 351 extracts the encoded data included in the accumulated bit stream, and feeds the encoded data to the decoding section 352.

The decoding section 352 acquires the encoded data fed from the accumulation buffer 351. The decoding section 352 decodes the encoded data acquired. At this time, the decoding section 352 applies entropy decoding (lossless decoding), for example, CABAC, CAVLC, or the like. In other words, the decoding section 352 decodes the encoded data by using a decoding method corresponding to the encoding method for the encoding processing executed by the encoding section 255. The decoding section 352 decodes the encoded data to derive quantized coefficient data. The decoding section 352 feeds the derived quantized coefficient data to the inverse quantization section 353.

In addition, in a case where an error (decoding error) occurs in the decoding processing of the decoding section 352, the decoding section 352 generates error information indicating the decoding error and feeds the error information to the error information transmission section 323.

The inverse quantization section 353 executes inverse quantization processing on the quantized coefficient data to derive transformed coefficient data. The inverse quantization processing is inverse processing of the quantization processing executed in the quantization section 254. The inverse quantization section 353 feeds the derived transformed coefficient data to the inverse coefficient transform section 354.

The inverse coefficient transform section 354 acquires the transformed coefficient data fed from the inverse quantization section 353. The inverse coefficient transform section 354 performs inverse coefficient transform processing on the transformed coefficient data to derive residual data. The inverse coefficient transform processing is inverse processing of the coefficient transform processing executed in the coefficient transform section 253. The inverse coefficient transform section 354 feeds the derived residual data to the calculation section 355.

The calculation section 355 acquires the residual data fed from the inverse coefficient transform section 354 and the predicted image fed from the prediction section 359. The calculation section 355 adds the residual data and the predicted image corresponding to the residual data to derive a local decoded image. The calculation section 355 feeds the derived local decoded image to the in-loop filter section 356 and the frame memory 358.

The in-loop filter section 356 acquires the local decoded image fed from the calculation section 355. The in-loop filter section 356 executes filter processing on the local decoded image as appropriate. For example, the in-loop filter section 356 can apply a bilateral filter as the filter processing of the in-loop filter section 356. For example, the in-loop filter section 356 can apply a deblocking filter (DBF) as the filter processing of the in-loop filter section 356. For example, the in-loop filter section 356 can apply an adaptive offset filter (SAO (Sample Adaptive Offset)) as the filter processing of the in-loop filter section 356. For example, the in-loop filter section 356 can apply an adaptive loop filter (ALP) as the filter processing of the in-loop filter section 356. In addition, the in-loop filter section 356 can apply multiple filters of these filters in combination as filter processing. Note that which of the filters is applied and in which order the filters are applied can freely be determined and can be selected as appropriate. For example, the in-loop filter section 356 applies, as filter processing, the four in-loop filters of the bilateral filter, the deblocking filter, the adaptive offset filter, and the adaptive loop filter in this order. Needless to say, the in-loop filter section 356 may execute any filter processing, and the filter processing is not limited to the above-described examples. For example, the in-loop filter section 356 may apply a Wiener filter or the like.

The in-loop filter section 356 executes filter processing corresponding to the filter processing executed by the in-loop filter section 260. The in-loop filter section 356 feeds the sort buffer 357 and the frame memory 358 with a local decoded image that has been subjected to the filter processing.

The sort buffer 357 uses, as input, the local decoded image fed from the in-loop filter section 356 and holds (stores) the local decoded image. The sort buffer 357 uses the local decoded image to reconstruct the decoded image on a per picture basis and holds the decoded images (stores the decoded images in the buffer). The sort buffer 357 sorts the acquired decoded images arranged in order of decoding, to be arranged in order of reproduction. The sort buffer 357 outputs, as video data, the group of decoded images sorted in order of reproduction, to the outside of the image decoding apparatus 112.

The frame memory 358 acquires the local decoded image fed from the calculation section 355, reconstructs the decoded image on a per picture basis, and stores the decoded image in a buffer in the frame memory 358. In addition, the frame memory 358 acquires the local decoded image that has been subjected to the in-loop filter processing, which is fed from the in-loop filter section 356, reconstructs the decoded image on a per picture basis, and stores the decoded image in the buffer in the frame memory 358. The frame memory 358 feeds, as a reference image, the decoded image stored in the frame memory 358 (or a part of the decoded image) to the prediction section 359.

The prediction section 359 acquires the decoded image (or a part of the decoded image) read from the frame memory 358. The prediction section 359 executes prediction processing in the prediction mode adopted during encoding, and references the decoded image as a reference image to generate a predicted image. The prediction section 359 feeds the predicted image to the calculation section 355.

### Flow of Image Encoding Processing

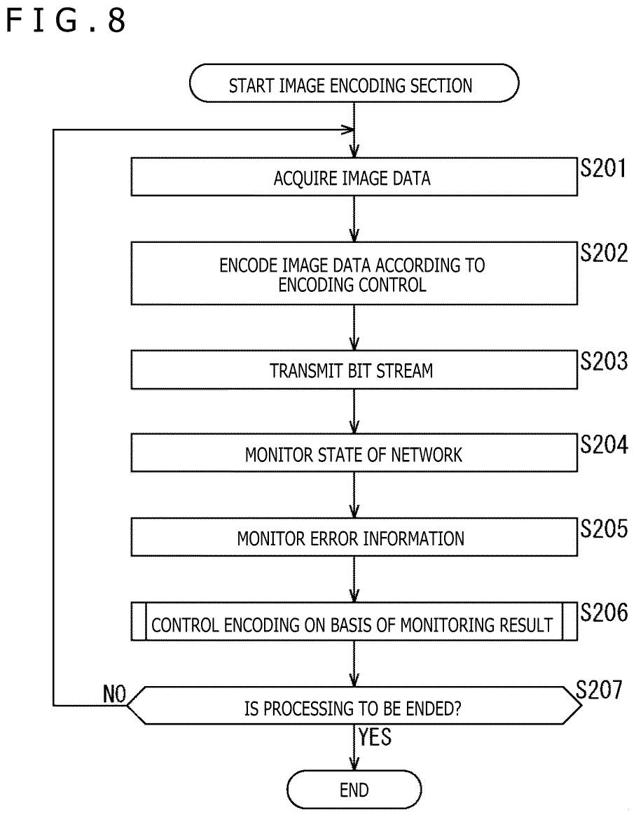

Now, processing executed in the image transmission system 100 will be described. With reference to a flowchart in FIG. 8, an example of a flow of image encoding processing executed by the image encoding apparatus 111 will be described.

When the image encoding processing is started, in step S201, the encoding section 211 acquires image data of a video to be transmitted.

In step S202, the encoding section 211 encodes the image data acquired in step S201, according to the encoding control of the encoding control section 213, to generate a bit stream.

In step S203, the data transmission section 221 transmits the bit stream generated in step S202 to the image decoding apparatus 112 via the wireless network 121 (eMBB).

In step S204, the network state monitoring section 222 monitors the state of the wireless network 121 and feeds the QoE information to the encoding control section 213 as appropriate.

In step S205, the error information monitoring section 223 monitors transmission of error information via the wireless network 122. In a case where the image decoding apparatus 112 transmits the error information via the wireless network 122, the error information monitoring section 223 receives and feeds the error information to the encoding control section 213.

In step S206, the encoding control section 213 controls the encoding processing executed in step S202, on the basis of results of processing (results of monitoring) in steps 204 and 205.

In step S207, the encoding control section 213 determines whether or not to end the image encoding processing. In a case where the video is being continuously encoded and the image encoding processing is determined not to be ended, the processing returns to step S201 to repeat the subsequent processing.

In addition, in step S207, in a case where the image encoding processing is determined to be ended, the image encoding processing ends.

### Flow of Image Decoding Processing

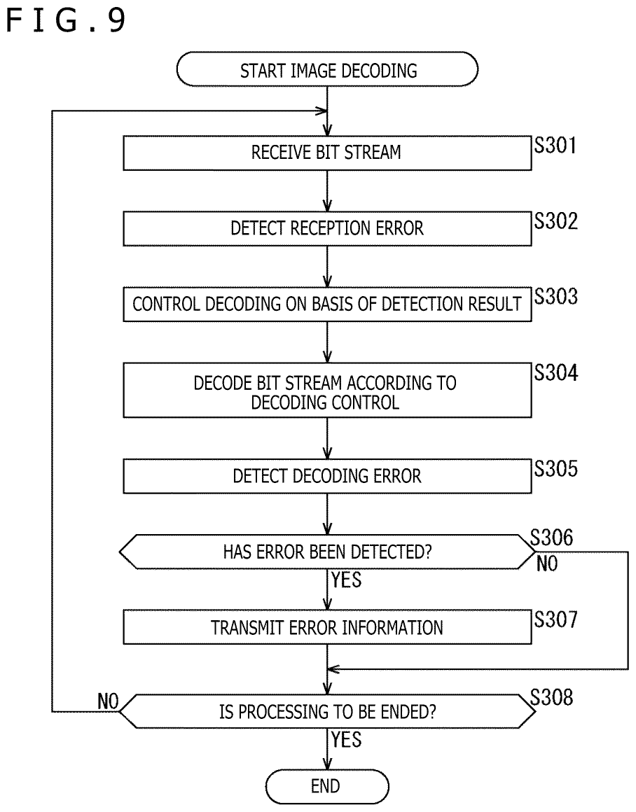

Now, an example of a flow of image decoding processing executed by the image decoding apparatus 112 will be described with reference to a flowchart in FIG. 9.

When the image decoding processing is started, in step 301, the data reception section 321 receives a bit stream transmitted from the image encoding apparatus 111 via the wireless network 121 (eMBB).

In step S302, the reception error detection section 322 monitors the reception processing in step S301, and in a case where a reception error occurs, detects the reception error.

In step S303, the decoding control section 312 controls processing (decoding processing) in step S304 described below, on the basis of the result of reception error detection in step S302.

In step S304, the decoding section 313 decodes the bit stream received in step S301, according to the decoding control in step S303, to generate image data of a decoded video. The image data is output to the outside of the image decoding apparatus 112.

In step S305, in a case where a decoding error occurs in the decoding processing in step S304, the decoding section 313 detects the decoding error.

In step S306, the error information transmission section 323 determines whether or not an error has been detected. That is, the error information transmission section 323 determines whether or not a reception error has been detected in step S302 and whether or not a decoding error has been detected in step S305. In a case where an error is detected, that is, at least any one of a reception error and a decoding error is detected, the processing proceeds to step S307.

In step S307, the error information transmission section 323 transmits error information indicating the detected error, to the image encoding apparatus 111 via the wireless network 122 (URLLC). When the processing in step S307 ends, the processing proceeds to step S308.

In addition, in step S306, in a case where no error is determined to have been detected, that is, neither a reception error nor a decoding error is determined to have been detected, the processing in step S307 is skipped, and the processing proceeds to step S308.

In step S308, the error information transmission section 323 determines whether or not to end the image decoding processing. In a case where the bit stream is being continuously transmitted and the image decoding processing is determined not to be ended, the processing returns to step S301, and the subsequent processing is repeated.

In addition, in step S308, in a case where the image decoding processing is determined to be ended, the image decoding processing ends.

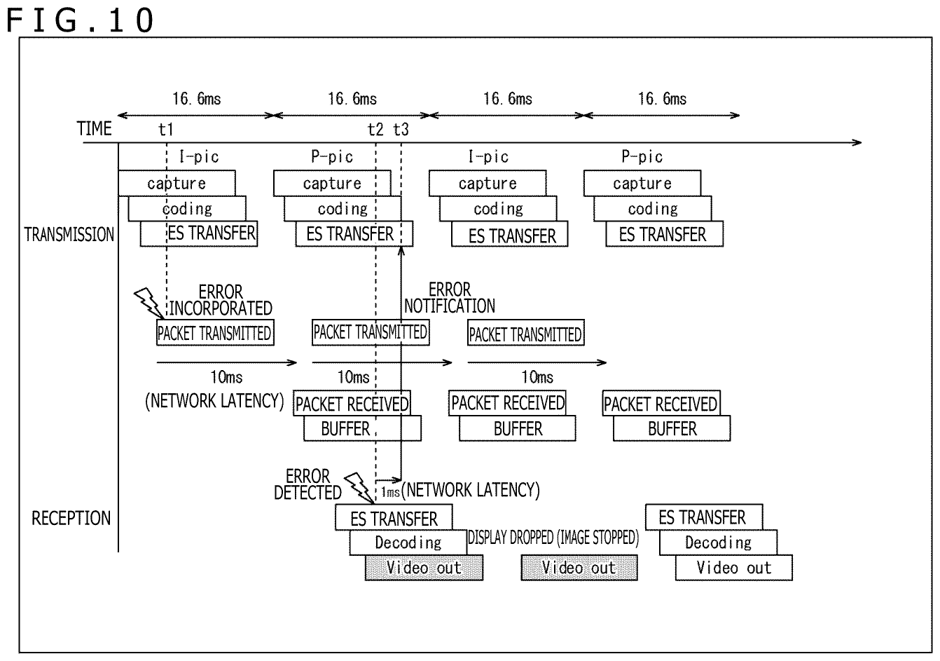

As described above, when the error information is transmitted via the wireless network 122 (URLLC) enabling transmission involving lower latency than the wireless network 121 (eMBB) that transmits the bit stream of the video, the latency related to the transmission of the error information can be made shorter than the latency in the example in FIG. 2, as depicted in FIG. 10. For example, in the case of FIG. 10, a loss in decoded image can be reduced to two frames.

In other words, the embodiment enables suppression of an increase in time period in which the image quality of the decoded image is degraded due to an error occurring on the reception side when the encoded data of the video is transmitted.

### 3. Second Embodiment

### Intra Stripe

Note that any method for encoding control may be used to prevent an error from propagating to the subsequent frames. For example, in a case where a technology referred to as an intra stripe is applied in image encoding, this intra stripe may be utilized.

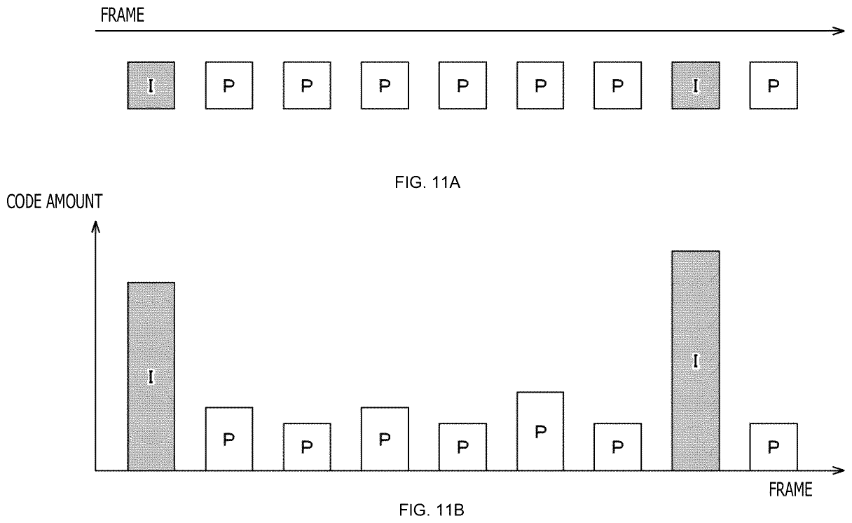

For example, as depicted in A of FIG. 11, each frame of the video is assumed to include an intra frame (I) corresponding to an intra-coded frame and an inter frame (P) corresponding to an inter-coded frame.

In that case, as depicted in B of FIG. 11, the code amount of intra frames may increase extremely compared to the code amount of inter frames. The system needs to be adapted to the intra frames having a larger code amount, leading to an increased capacity of the buffer and increased latency.

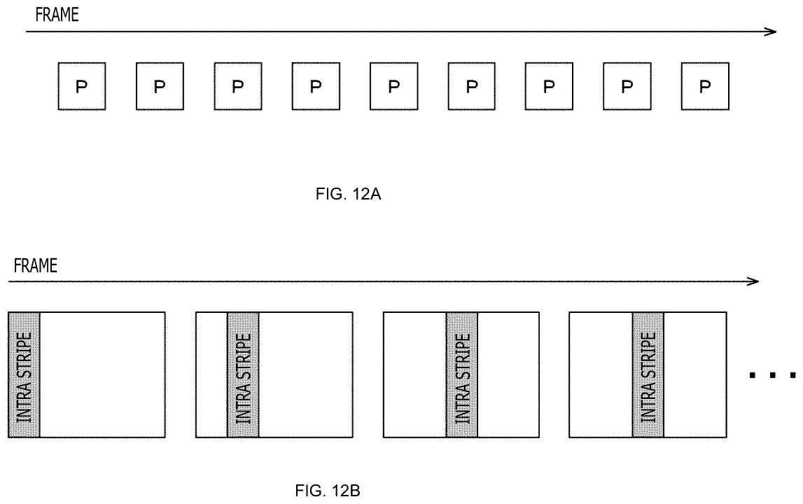

Accordingly, as depicted in A of FIG. 12, all frames are set as inter frames (P), and a part of each frame is set as an intra region and is intra-coded. The intra region is also referred to as an intra stripe. As depicted in B of FIG. 11, the position of the intra stripe (intra region) is shifted for each frame and passes through the entire frame over a predetermined number of frames. For example, the frame is divided into N subregions, and one of the subregions is set as an intra region. Then, the intra region is shifted to the adjacent subregion for each frame, and returns to the original position after N frames.

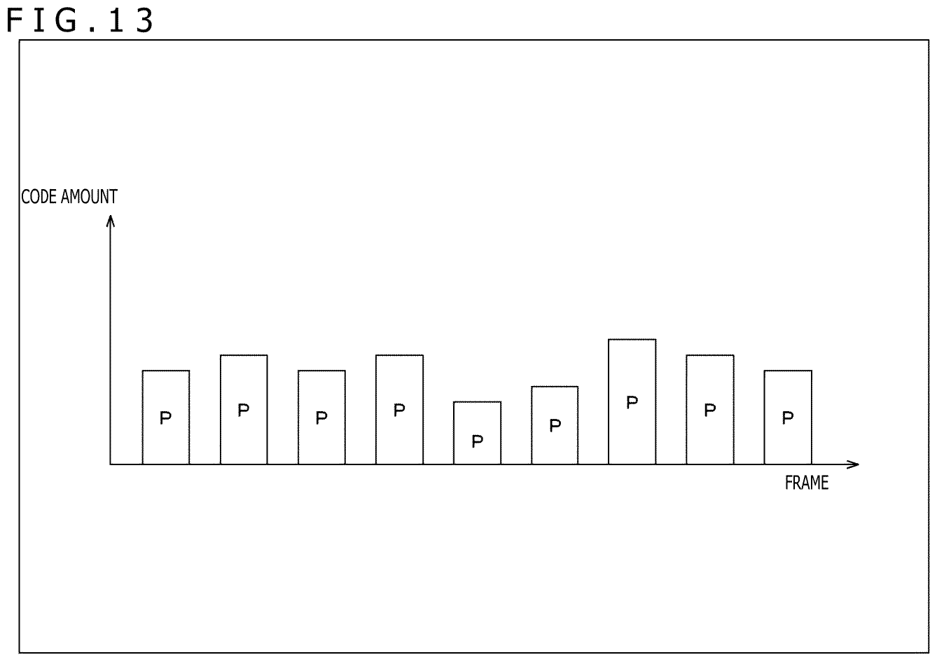

As depicted in FIG. 13, the above-described configuration allows the amount of each frame to be smoothed compared to the example in B of FIG. 11. This allows an increased capacity of the buffer and increased latency to be suppressed.

Note that, also in a case where an error occurs, the intra region passes through the entire frame to allow a decoded image for one frame to be obtained. For example, by performing vector control as in a method described in PTL 1, propagation of an error can be suppressed.

However, in the case of this method, the vector control may degrade the image quality of the decoded image of the intra region. Accordingly, even in a case where a decoded image for one frame is obtained, the decoded image may have degraded quality. Consequently, when the encoded data of the image is transmitted, the time period in which the image quality of the decoded image is degraded due to an error occurring on the reception side may be increased.

### Position Control of Intra Stripe

Accordingly, in a case where error information is acquired, the encoding control may be performed to return the position of the intra stripe to the initial position.

In other words, for the video to be transmitted, when each frame is encoded, a part of the frame is assumed to be set as an intra region and intra-coded, and the position of the intra region is assumed to be shifted in a predetermined direction for each frame in such a manner as to pass through the entire frame over a predetermined number of frames. In such a case, the encoding control section 213 may return the position of the intra region to the initial position when the error information monitoring section 223 acquires error information.

For example, as depicted in B of FIG. 12, the intra region is assumed to be a subregion of a frame, the subregion including multiple blocks arranged in the vertical direction of the frame, the initial position of the intra region is assumed to correspond to the left end of the frame, and the position of the intra region is assumed to be shifted rightward for each frame. In such a case, the encoding control section 213 may return the position of the intra region to the left end of the frame in a case where the error information monitoring section 223 acquires error information.

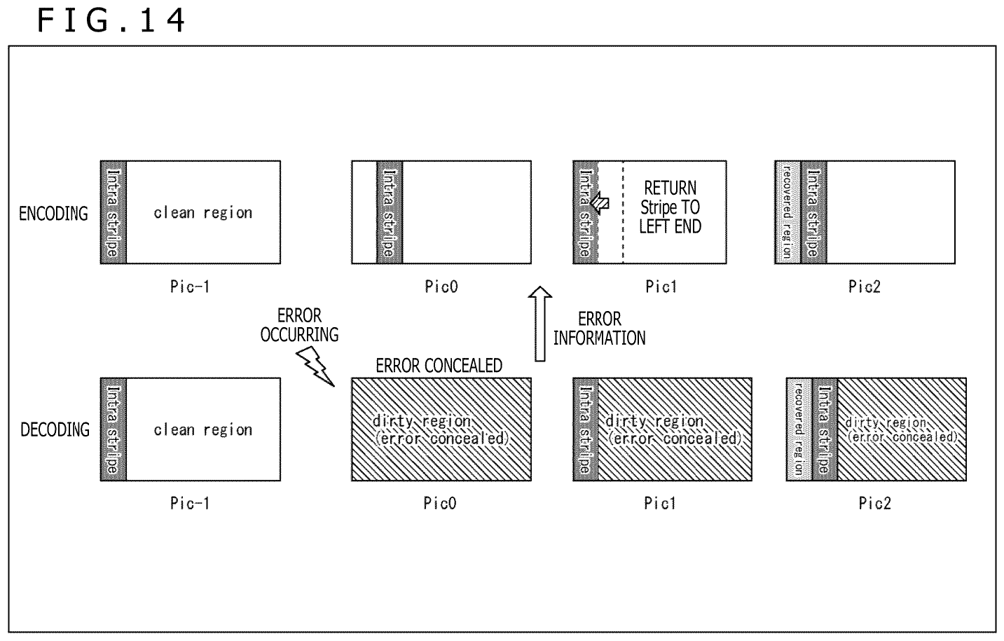

For example, as depicted in FIG. 14, in a case where an error occurs in Pic0, the encoding control section 213 controls and causes the encoding section 211 to shift the position of the intra stripe in Pic1 to the initial position (left end of the frame).

Such control allows a decoded image of the intra stripe to be obtained without degrading image quality. Accordingly, once a decoded image for one frame is obtained, a frame image with image quality not degraded can be obtained. Consequently, the embodiment enables suppression of an increase in time period in which the image quality of the decoded image is degraded due to an error occurring on the reception side when the encoded data of the image is transmitted.

### Flow of Encoding Control Processing

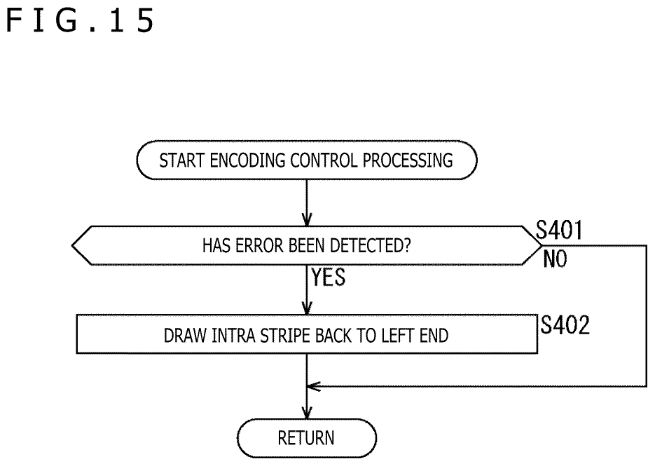

An example of the flow of encoding control processing executed in step S206 in FIG. 8 in the above-described case will be described with reference to a flowchart in FIG. 15.

When the encoding control processing is started, the encoding control section 213 determines in step S401 whether or not an error has been detected. In a case where an error is determined to have been detected, the processing proceeds to step S402.

In step S402, the encoding control section 213 controls and causes the encoding section 211 to draw the intra stripe back to the left end of the frame (initial position). When the processing in step S402 ends, the encoding control processing ends, and the processing then proceeds to step S207 in FIG. 8.

In addition, in step S401, in a case where no error is determined to have been detected, the processing in step S402 is skipped, and the encoding control processing ends. The processing then proceeds to step S207 in FIG. 8.

Executing the encoding control processing as described above enables suppression of an increase in time period in which the image quality of the decoded image is degraded due to an error occurring on the reception side when the encoded data of the image is transmitted.

Note that the boundaries of the intra stripe may be mode-constrained in such a manner as to prevent error data from propagating from the error region. For example, in the case of VVC described in NPL 4, the intra stripe boundaries are set as virtual boundaries and encoded to allow error data to be prevented from being incorporated.

### 4. Third Embodiment

### Insertion of Intra Frame

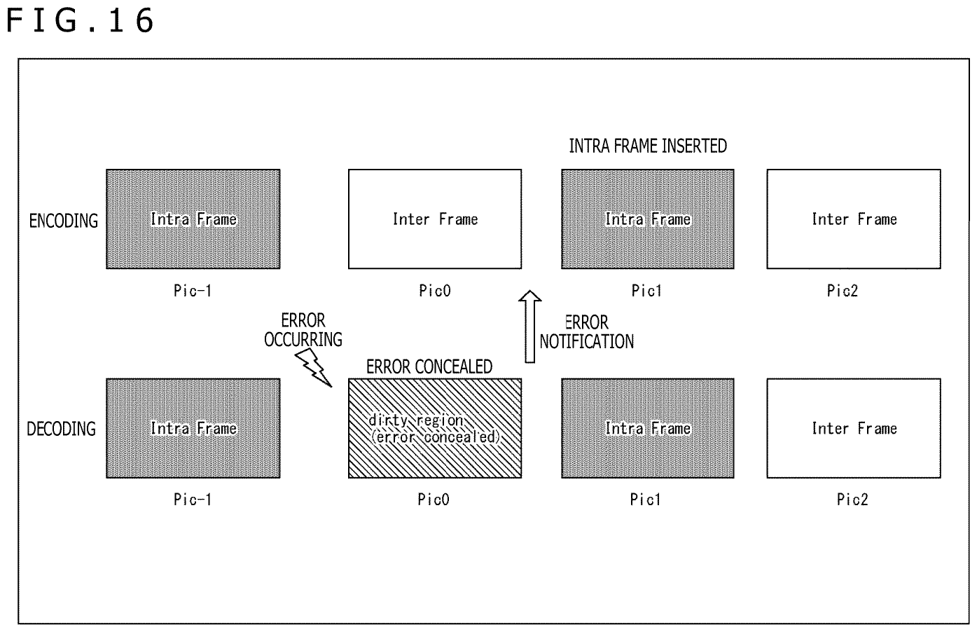

For example, as depicted in A of FIG. 11, each frame of the video is assumed to include an intra frame (I) corresponding to an intra-coded frame and an inter frame (P) corresponding to an inter-coded frame. In that case, control may be performed in such a manner as to insert an intra frame as depicted in FIG. 16.

In other words, the video to be transmitted is assumed to include an intra frame corresponding to an intra-coded frame. In that case, when the error information monitoring section 223 acquires error information, the encoding control section 213 may set the next frame to be encoded as an intra frame.

For example, as depicted in FIG. 16, in a case where an error occurs in Pic0, the encoding control section 213 controls and causes the encoding section 211 to set Pic1 as an intra frame.

Such control allows the error to be prevented from propagating to the frames subsequent to Pic2. Consequently, the embodiment enables suppression of an increase in time period in which the image quality of the decoded image is degraded due to an error occurring on the reception side when the encoded data of the image is transmitted.

### Flow of Encoding Control Processing

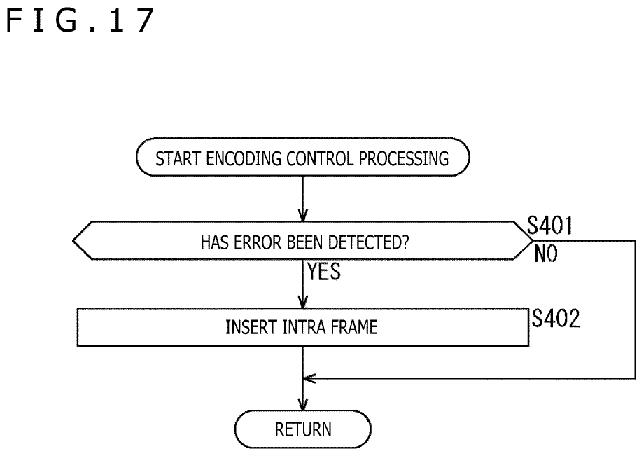

An example of the flow of encoding control processing executed in step S206 in FIG. 8 in the above-described case will be described with reference to a flowchart in FIG. 17.

When the encoding control processing is started, the encoding control section 213 determines in step S431 whether or not an error has been detected. In a case where an error is determined to have been detected, the processing proceeds to step S432.

In step S432, the encoding control section 213 controls and causes the encoding section 211 to insert an intra frame. When the processing in step S432 ends, the encoding control processing ends, and the processing proceeds to step S207 in FIG. 8.

In addition, in step S431, in a case where no error is determined to have been detected, the processing in step S432 is skipped, and the encoding control processing ends. The processing then proceeds to step S207 in FIG. 8.

Executing the encoding control processing as described above enables suppression of an increase in time period in which the image quality of the decoded image is degraded due to an error occurring on the reception side when the encoded data of the image is transmitted.

### 5. Fourth Embodiment

### Another Configuration 1 of Image Transmission System

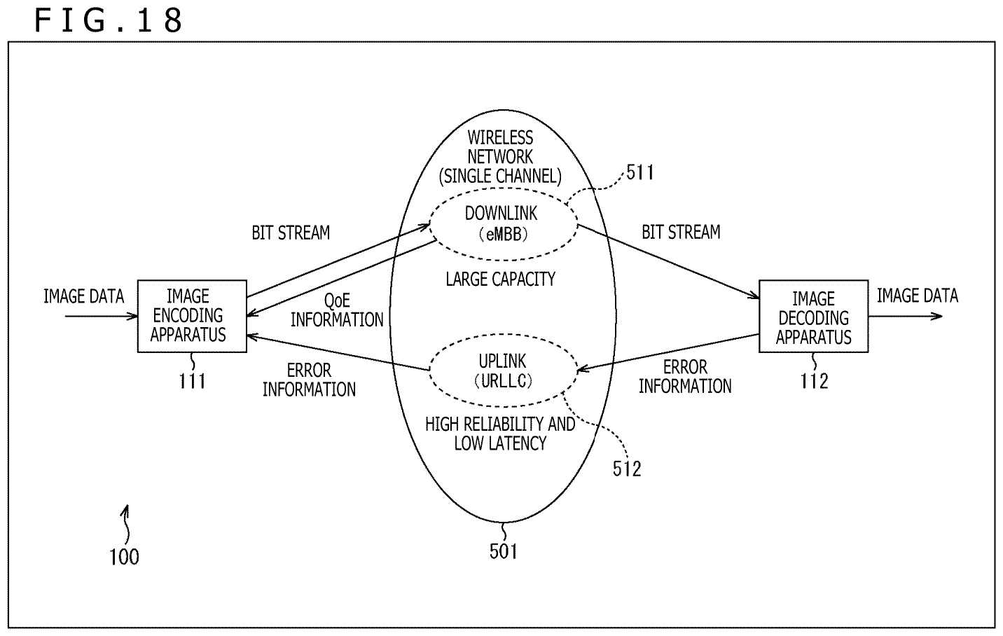

The configuration of the image transmission system 100 is not limited to the example in FIG. 3. For example, as depicted in FIG. 18, transmission of a bit stream and transmission of error information may be performed in the same channel (same frequency band).

In the case of the example of FIG. 18, the bit stream is transmitted in a downlink 511 of a wireless network 501, whereas the error information is transmitted in an uplink 512 of the same wireless network 501 (that is, the same frequency band). Such a configuration allows the bit stream to be transmitted by communication in the large-capacity use case (eMBB), while allowing the error information to be transmitted by communication in the low-latency use case (URLLC).

In other words, a first wireless channel that transmits the bit stream may be a downlink having the same frequency band as that of a second wireless channel that transmits the error information, the first wireless channel being a wireless channel satisfying the requirement for the eMBB (enhanced Mobile broadband) in a wireless communication system satisfying the provision IMT (International Mobile Telecommunications)-2020 specified by the International Telecommunication Union, while the second wireless channel may be an uplink having the same frequency band as that of the first wireless channel transmitting the error information, the second wireless channel being a wireless satisfying the requirement for the URLLC (Ultra Reliable Low Latency Communication) in the wireless communication system.

Such a configuration enables suppression of an increase in time period in which the image quality of the decoded image is degraded due to an error occurring on the reception side when the encoded data of the image is transmitted, as is the case with the example of FIG. 3.

Note that control may be performed to stop eMBB communication in the downlink during occurrence of an error in order to restrain the quality of URLLC communication in the uplink from being degraded by interference of the eMBB communication (that is, in order to ensure the quality of the URLLC communication).

### Another Configuration 2 of Image Transmission System

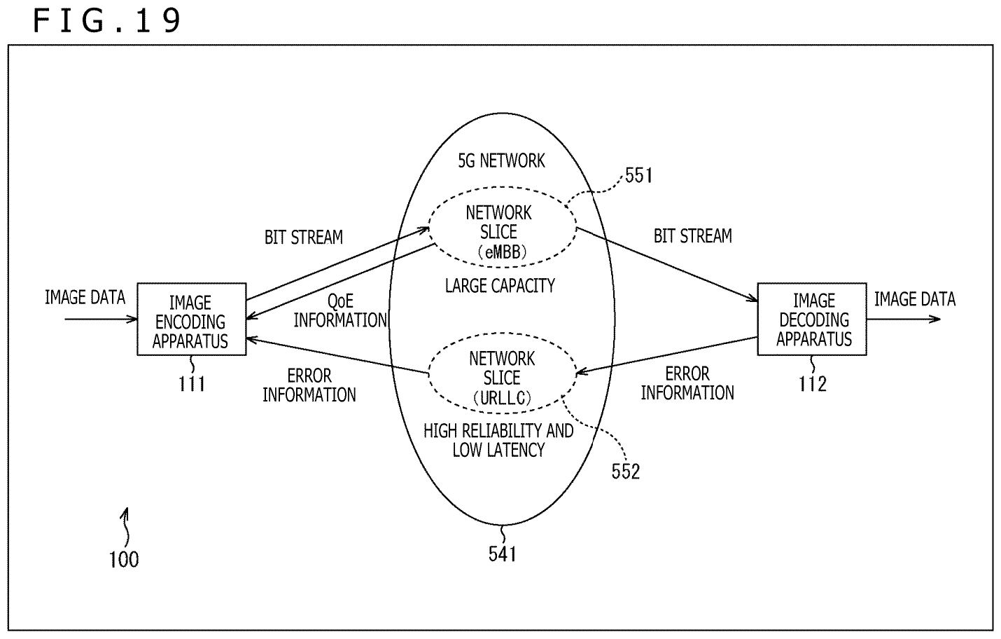

In addition, for example, as depicted in FIG. 19, transmission of the bit stream and transmission of the error information may be performed in network slices different from each other. For example, in 5G, network slicing can be used to virtually divide a network into multiple network slices, each of which can be utilized for transmission. Such a function may be utilized for transmission of the bit stream and transmission of the error information.

In the case of the example of FIG. 19, the bit stream is transmitted in one network slice 551 of a 5G network 541, whereas the error information is transmitted in another network slice 552 of the same 5G network 541. Such a configuration allows the bit stream to be transmitted by communication in the large-capacity use case (eMBB), while allowing the error information to be transmitted by communication in the low-latency use case (URLLC).

In other words, a first wireless channel that transmits the bit stream may be a network slice different from a network slice corresponding to a second wireless channel that transmits the error information, the first wireless channel being a wireless channel satisfying the requirement for the eMBB (enhanced Mobile broadband) in a wireless communication system satisfying the provision IMT (International Mobile Telecommunications)-2020 specified by the International Telecommunication Union, while the second wireless channel may be a network slice different from the network slice corresponding to the first wireless channel, the second wireless channel being a wireless channel satisfying the requirement for the URLLC (Ultra Reliable Low Latency Communication) in the wireless communication system.

Such a configuration enables suppression of an increase in time period in which the image quality of the decoded image is degraded due to an error occurring on the reception side when the encoded data of the image is transmitted, as is the case with the example of FIG. 3.

### Another Configuration 3 of Image Transmission System

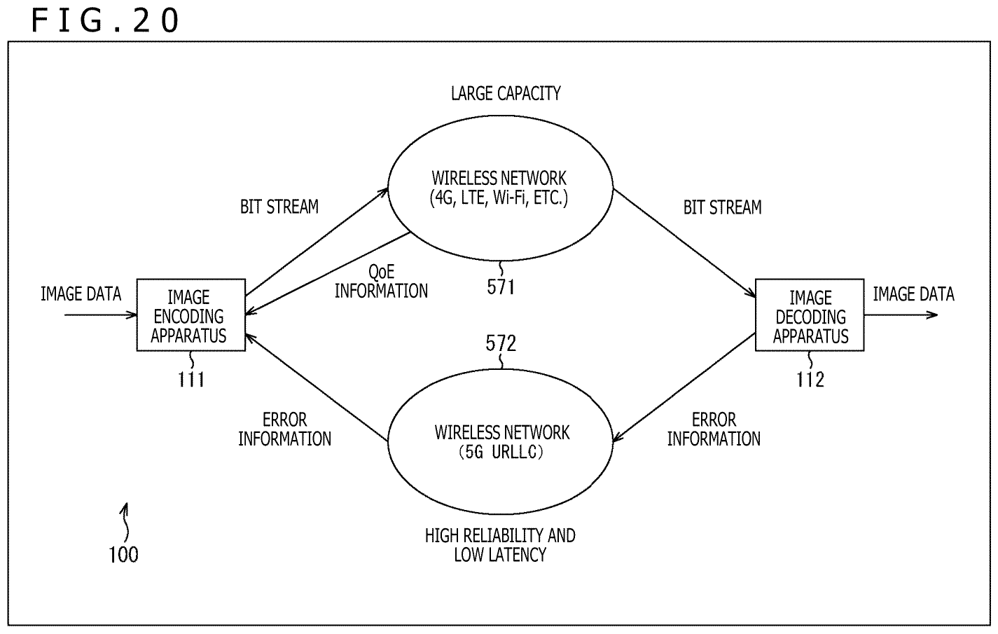

In addition, for example, as depicted in FIG. 20, transmission of the bit stream and transmission of the error information may be performed in channels complying with wireless communication standards different from each other.

In the case of the example of FIG. 20, the bit stream is transmitted in a wireless network 571, whereas the error information is transmitted in a wireless network 572 complying with a communication standard different from a communication standard with which the wireless network 571 complies.

The wireless network 571 may be, for example, a wireless channel complying with the IMT (International Mobile Telecommunications)-Advanced standard (hereinafter also referred to as 4G). In addition, the wireless network 571 may be a wireless channel complying with LTE (Long Term Evolution) formulated by the 3GPP (Third Generation Partnership Project). Further, the wireless network 571 may be a wireless channel using the IEEE (Institute of Electrical and Electronics Engineers) 802.11 standard (hereinafter also referred to as Wi-Fi (registered trademark)). Needless to say, the wireless network 571 may be a channel complying with a communication standard other than the above-described communication standards. In contrast, the wireless network 572 may be, for example, a 5G wireless channel.

Such a configuration allows the bit stream to be transmitted by large-capacity communication, while allowing the error information to be transmitted by communication in the low-latency use case (URLLC).

In other words, a first wireless channel that transmits the bit stream may be a wireless channel complying with the provision IMT (International Mobile Telecommunications)-Advanced specified by the International Telecommunication Union, a wireless channel complying with LTE (Long Term Evolution) formulated by the 3GPP (Third Generation Partnership Project), or a wireless channel using the IEEE (Institute of Electrical and Electronics Engineers) 802.11 standard. In addition, the second wireless channel that transmits the error information may be a wireless channel satisfying the requirement for the URLLC (Ultra Reliable Low Latency Communication) in the wireless communication system satisfying the provision IMT-2020 specified by the International Telecommunication Union.

Such a configuration enables suppression of an increase in time period in which the image quality of the decoded image is degraded due to an error occurring on the reception side when the encoded data of the image is transmitted, as is the case with the example of FIG. 3.

### 6. Supplementary Note

### Computer

Hardware or software can be used to execute the above-described series of processing operations. In a case where software is used to execute the series of processing operations, a program constituting the software is installed in a computer. Here, the computer includes a computer incorporated in dedicated hardware, a general-purpose personal computer, for example, which has various programs installed therein to be able to execute various functions, and the like.

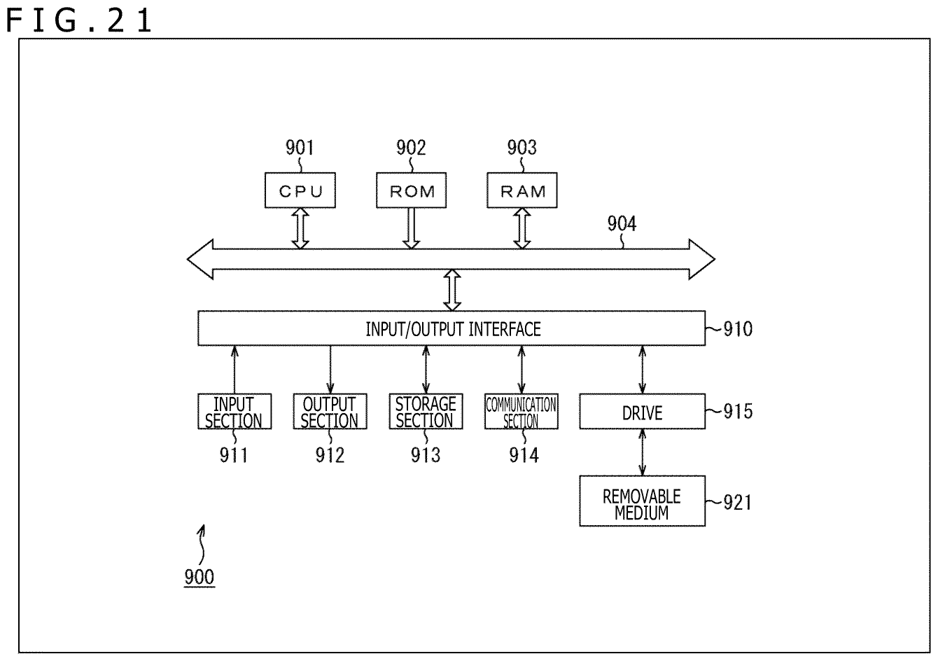

FIG. 21 is a block diagram depicting a configuration example of hardware of a computer executing a series processing operations described above according to programs.

In a computer 900 depicted in FIG. 21, a CPU (Central Processing Unit) 901, a ROM (Read Only Memory) 902, and a RAM (Random Access Memory) 903 are connected to each other via a bus 904.

The bus 904 also connects to an input/output interface 910. The input/output interface 910 connects to an input section 911, an output section 912, a storage section 913, a communication section 914, and a drive 915.

The input section 911 includes, for example, a keyboard, a mouse, a microphone, a touch panel, an input terminal, and the like. The output section 912 includes, for example, a display, a speaker, an output terminal, and the like. The storage section 913 includes, for example, a hard disk, a RAM disk, a nonvolatile memory, and the like. The communication section 914 includes, for example, a network interface. The drive 915 drives a removable medium 921 such as a magnetic disk, an optical disc, a magneto-optic disc, or a semiconductor memory.

In the computer configured as described above, the CPU 901 performs the above-described series of processing operations, for example, by loading programs stored in the storage section 913, into the RAM 903 via the input/output interface 910 and the bus 904, and executing the programs in the RAM 903. The RAM 903 also stores, as appropriate, data required for the CPU 901 to execute various processing operations, for example.

Programs executed by the computer can be applied by being recorded in a removable medium 921 serving, for example, as a package medium or the like. In that case, the programs can be installed in the storage section 913 via the input/output interface 910 by mounting the removable medium 921 in the drive 915.

In addition, the programs can be provided via a wired or wireless transmission medium such as a local area network, the Internet, or digital satellite broadcasting. In that case, the programs can be received by the communication section 914 and installed in the storage section 913.

In addition, the programs can be installed in the ROM 902 or the storage section 913 in advance.

### Scope of Application of Present Technology

The present technology can be applied to any image encoding and decoding methods.

The present technology can be applied to any configuration. For example, the present technology can be applied to various types of electronic equipment such as transmitters and receivers (for example, television receivers and cellular phones) for satellite broadcasting, delivery on the Internet, delivery to terminals in cellular communication, and the like and apparatuses (for example, hard disk recorders and cameras) that record or reproduce images in or from optical discs, magnetic disks, flash memories, and the like.

In addition, for example, the present technology can be implemented as a configuration corresponding to a part of an apparatus such as a processor (for example, a video processor) as a system LSI (Large Scale Integration) or the like, a module (for example, a video module) using multiple processors or the like, a unit (for example, a video unit) using multiple modules or the like, or a set (for example, a video set) including a unit with additional functions.

In addition, for example, the present technology can also be applied to a network system including multiple apparatuses. For example, the present technology may be implemented as cloud computing in which multiple apparatuses cooperates in sharing processing via the network. For example, the present technology may be implemented in cloud services that provide services related to images (videos) to any terminals such as computers, AV (Audio Visual) equipment, portable information processing terminals, or IoT (Internet of Things) devices.

Note that the system as used herein means a set of multiple components (apparatuses, modules (parts), or the like) regardless of whether or not all the components are located in the same housing. Consequently, the system refers to multiple apparatuses placed in separate housings and connected to each other via the network as well as one apparatus including multiple modules placed in one housing.

### Fields and Applications to which Present Technology is Applicable

A system, an apparatus, a processing section, and the like to which the present technology is applied can be utilized in any fields, for example, traffic, healthcare, crime prevention, agriculture, dairy industry, mining, beauty care, factories, home electrical appliances, meteorology, nature monitoring, or the like. In addition, the system, apparatus, processing section, and the like to which the present technology is applied can be used for any applications.

For example, the present technology can be applied to systems and devices used to provide content for viewing and listening and the like. In addition, for example, the present technology can be applied to systems and devices used for traffic such as administration of traffic situation or self-driving control. Further, for example, the present technology can be applied to systems and devices used for security. In addition, for example, the present technology can be applied to systems and devices used for automatic control of machines and the like. Further, for example, the present technology can be applied to systems and devices used for agriculture or dairy industry. In addition, for example, the present technology can be applied to systems and devices that monitor the state of nature such as volcanoes, forests, or oceans, wild animals, and the like. Further, for example, the present technology can be applied to systems and devices used for sports.

### Others

Embodiments of the present technology are not limited to the above-described embodiments and can be varied without departing from the spirits of the present technology.

For example, the configuration described above as one apparatus (or processing section) may be divided and configured into multiple apparatuses (or processing sections). In contrast, the configuration described above as multiple apparatuses may be brought together and configured into one apparatus (or processing section). In addition, each apparatus (or each processing section) may include additional configuration other than those described above. Further, a part of the configuration of one apparatus (or one processing section) may be included in the configuration of another apparatus (or another processing section) as long as the configuration and operation of the system as a whole remain substantially unchanged.

In addition, for example, the above-described programs may be executed in any apparatus. In that case, it is sufficient if the apparatus includes required functions (functional blocks or the like) and can obtain required information.

In addition, for example, one apparatus may execute each step in one flowchart, or multiple apparatuses may execute the steps in a shared manner. Further, in a case where one step includes multiple processing operations, one apparatus may execute the multiple processing operations, or multiple apparatuses may execute the processing operations in a shared manner. In other words, multiple processing operations included in one step can also be executed as processing in multiple steps. In contrast, the processing described as multiple steps can also be brought together and executed as one step.

In addition, for example, for the programs executed by the computer, the processing in the steps describing each program may be chronologically executed along the order described herein or may be executed in parallel or individually at required timings such as when the processing is invoked. In other words, the processing in the steps may be executed in an order different from that described above as long as no inconsistency occurs. Further, the processing in the steps describing the program may be executed in parallel or in combination with processing of another program.

In addition, for example, multiple technologies related to the present technology can be independently and unitarily implemented as long as no inconsistency occurs. Needless to say, the present technologies can be implemented together in any plural number. For example, a part or all of the present technology described in any of the embodiments can be implemented in combination with a part or all of the present technology described in another of the embodiments. In addition, a part or all of any of the present technologies described above can be implemented together with any other technology not described above.

Note that the present technology can also adopt such configurations as described below.

(1)

An information processing apparatus including:
an error information acquisition section that acquires error information transmitted, via a second wireless channel, from a reception apparatus that receives encoded data of a video transmitted via a first wireless channel, the second wireless channel enabling transmission involving lower latency than the first wireless channel; and
an encoding control section that controls encoding of the video on the basis of the error information acquired by the error information acquisition section.
   (2)

The information processing apparatus according to (1), in which,
in the video, when each frame is encoded, a part of the frame is set as an intra region and intra-coded,
a position of the intra region is shifted in a predetermined direction for each of the frames in such a manner as to pass through an entire frame over a predetermined number of frames, and,
in a case where the error information acquisition section acquires the error information, the encoding control section returns the position of the intra region to an initial position.
   (3)

The information processing apparatus according to (2), in which
the intra region includes a subregion of the frame, the subregion including multiple blocks arranged in a vertical direction of the frame,
the initial position corresponds to a left end of the frame, and the position of the intra region is shifted rightward for each of the frames, and,
in the case where the error information acquisition section acquires the error information, the encoding control section returns the position of the intra region to the left end of the frame.
   (4)

The information processing apparatus according to (1), in which
the video includes an intra frame corresponding to an intra-coded frame, and,
in a case where the error information acquisition section acquires the error information, the encoding control section sets, as the intra frame, a next frame to be encoded.
   (5)

The information processing apparatus according to any one of (1) to (4), in which
the error information includes information indicating an error occurring upon reception of the encoded data.
   (6)

The information processing apparatus according to any one of (1) to (5), in which
the error information includes information indicating an error occurring upon decoding of the encoded data.
   (7)

The information processing apparatus according to any one of (1) to (6), further including:
an encoding section that encodes the video to generate the encoded data, in which
the encoding control section controls the encoding section on the basis of the error information acquired by the error information acquisition section.
   (8)

The information processing apparatus according to any one of (1) to (7), further including:
a wireless channel state monitoring section that monitors a state of the first wireless channel, in which
the encoding control section further controls encoding of the video on the basis of a state of the first wireless channel monitored by the wireless channel state monitoring section.
   (9)

The information processing apparatus according to any one of (1) to (8), in which
the first wireless channel and the second wireless channel are channels having frequency bands different from each other.
   (10)

The information processing apparatus according to (9), in which
the first wireless channel is a channel satisfying a requirement for eMBB (enhance Mobile broadband) in a wireless communication system satisfying a provision IMT (International Mobile Telecommunications)-2020 specified by the International Telecommunication Union, and
the second wireless channel is a channel satisfying a requirement for URLLC (Ultra Reliable Low Latency Communication) in the wireless communication system.
   (11)

The information processing apparatus according to any one of (1) to (8), in which
the first wireless channel is a downlink having the same frequency band as that of the second wireless channel, and is a wireless channel satisfying a requirement for eMBB (enhance Mobile broadband) in a wireless communication system satisfying a provision IMT (International Mobile Telecommunications)-2020 specified by the International Telecommunication Union, and
the second wireless channel is an uplink having the same frequency band as that of the first wireless channel, and is a wireless channel satisfying a requirement for URLLC (Ultra Reliable Low Latency Communication) in the wireless communication system.
   (12)

The information processing apparatus according to any one of (1) to (8), in which
the first wireless channel is a network slice different from a network slice corresponding to the second wireless channel, and is a wireless channel satisfying a requirement for eMBB (enhance Mobile broadband) in a wireless communication system satisfying a provision IMT (International Mobile Telecommunications)-2020 specified by the International Telecommunication Union, and
the second wireless channel is a network slice different from the network slice corresponding to the first wireless channel, and is a wireless channel satisfying a requirement for URLLC (Ultra Reliable Low Latency Communication) in the wireless communication system.
   (13)

The information processing apparatus according to any one of (1) to (8), in which
the first wireless channel and the second wireless channel are channels complying with wireless communication standards different from each other.
   (14)

The information processing apparatus according to (13), in which
the first wireless channel is a wireless channel complying with a provision IMT (International Mobile Telecommunications)-Advanced standard specified by the International Telecommunication Union, a wireless channel complying with LTE (Long Term Evolution) formulated by the 3GPP (Third Generation Partnership Project), or a wireless channel using an IEEE (Institute of Electrical and Electronics Engineers) 802.11 standard, and
the second wireless channel is a wireless channel satisfying a requirement for URLLC (Ultra Reliable Low Latency Communication) in a wireless communication system satisfying a provision IMT-2020 specified by the International Telecommunication Union.
   (15)

An information processing method including:
acquiring error information transmitted, via a second wireless channel, from a reception apparatus that receives encoded data of a video transmitted via a first wireless channel, the second wireless channel enabling transmission involving lower latency than the first wireless channel; and
controlling encoding of the video on the basis of the error information acquired.
   (16)

An information processing apparatus including:
a data reception section that receives encoded data of a video transmitted via a first wireless channel; and
an error information transmission section that transmits error information indicating an error related to the encoded data received by the data reception section, to a transmission source of the encoded data via a second wireless channel enabling transmission involving lower latency than the first wireless channel.
   (17)

The information processing apparatus according to (16), further including:
a reception error detection section that detects a reception error in reception of the encoded data by the data reception section, in which
the error information includes information indicating the reception error detected by the reception error detection section.
   (18)

The information processing apparatus according to (16) or (17), in which
the error information includes information indicating a decoding error related to decoding of the encoded data received by the data reception section.
   (19)

The information processing apparatus according to (18), further including:
a decoding section that decodes the encoded data received by the data reception section, in which
the error information transmission section acquires information indicating the decoding error which information is fed from the decoding section, and transmits the error information including the information indicating the decoding error.
   (20)

An information processing method including:
receiving encoded data of a video transmitted via a first wireless channel; and
transmitting error information indicating an error related to the encoded data, to a transmission source of the encoded data via a second wireless channel enabling transmission involving lower latency than the first wireless channel.

### REFERENCE SIGNS LIST

100: Image transmission system
111: Image encoding apparatus
112: Image decoding apparatus
121: Wireless network
122: Wireless network
211: Encoding section
212: Communication section
213: Encoding control section
221: Data transmission section
222: Network state monitoring section
223: Error information monitoring section
255: Encoding section
262: Prediction section
271: Inter prediction section
272: Intra prediction section
311: Communication section
312: Decoding control section
313: Decoding section
321: Data reception section
322: Reception error detection section
323: Error information transmission section
352: Decoding section
359: Prediction section
501: Wireless network
511: Downlink
512: Uplink
541: 5G network
551 and 552: Network slice
571: Wireless network
572: Wireless network
900: Computer

1. An information processing apparatus comprising:
an error information acquisition section that acquires error information transmitted, via a second wireless channel, from a reception apparatus that receives encoded data of a video transmitted via a first wireless channel, the second wireless channel enabling transmission involving lower latency than the first wireless channel; and
an encoding control section that controls encoding of the video on a basis of the error information acquired by the error information acquisition section.

2. The information processing apparatus according to claim 1, wherein,
in the video, when each frame is encoded, a part of the frame is set as an intra region and intra-coded,
a position of the intra region is shifted in a predetermined direction for each of the frames in such a manner as to pass through an entire frame over a predetermined number of frames, and,
in a case where the error information acquisition section acquires the error information, the encoding control section returns the position of the intra region to an initial position.

3. The information processing apparatus according to claim 2, wherein
the intra region includes a subregion of the frame, the subregion including multiple blocks arranged in a vertical direction of the frame,
the initial position corresponds to a left end of the frame, and the position of the intra region is shifted rightward for each of the frames, and,
in the case where the error information acquisition section acquires the error information, the encoding control section returns the position of the intra region to the left end of the frame.

4. The information processing apparatus according to claim 1, wherein
the video includes an intra frame corresponding to an intra-coded frame, and,
in a case where the error information acquisition section acquires the error information, the encoding control section sets, as the intra frame, a next frame to be encoded.

5. The information processing apparatus according to claim 1, wherein
the error information includes information indicating an error occurring upon reception of the encoded data.

6. The information processing apparatus according to claim 1, wherein
the error information includes information indicating an error occurring upon decoding of the encoded data.

7. The information processing apparatus according to claim 1, further comprising:
an encoding section that encodes the video to generate the encoded data, wherein
the encoding control section controls the encoding section on a basis of the error information acquired by the error information acquisition section.

8. The information processing apparatus according to claim 1, further comprising:
a wireless channel state monitoring section that monitors a state of the first wireless channel, wherein
the encoding control section further controls encoding of the video on a basis of a state of the first wireless channel monitored by the wireless channel state monitoring section.

9. The information processing apparatus according to claim 1, wherein
the first wireless channel and the second wireless channel are channels having frequency bands different from each other.

10. The information processing apparatus according to claim 9, wherein
the first wireless channel is a channel satisfying a requirement for eMBB (enhance Mobile broadband) in a wireless communication system satisfying a provision IMT (International Mobile Telecommunications)-2020 specified by the International Telecommunication Union, and
the second wireless channel is a channel satisfying a requirement for URLLC (Ultra Reliable Low Latency Communication) in the wireless communication system.

11. The information processing apparatus according to claim 1, wherein
the first wireless channel is a downlink having a same frequency band as that of the second wireless channel, and is a wireless channel satisfying a requirement for eMBB (enhance Mobile broadband) in a wireless communication system satisfying a provision IMT (International Mobile Telecommunications)-2020 specified by the International Telecommunication Union, and
the second wireless channel is an uplink having a same frequency band as that of the first wireless channel, and is a wireless channel satisfying a requirement for URLLC (Ultra Reliable Low Latency Communication) in the wireless communication system.

12. The information processing apparatus according to claim 1, wherein
the first wireless channel is a network slice different from a network slice corresponding to the second wireless channel, and is a wireless channel satisfying a requirement for eMBB (enhance Mobile broadband) in a wireless communication system satisfying a provision IMT (International Mobile Telecommunications)-2020 specified by the International Telecommunication Union, and
the second wireless channel is a network slice different from the network slice corresponding to the first wireless channel, and is a wireless channel satisfying a requirement for URLLC (Ultra Reliable Low Latency Communication) in the wireless communication system.

13. The information processing apparatus according to claim 1, wherein
the first wireless channel and the second wireless channel are channels complying with wireless communication standards different from each other.

14. The information processing apparatus according to claim 13, wherein
the first wireless channel is a wireless channel complying with a provision IMT (International Mobile Telecommunications)-Advanced standard specified by the International Telecommunication Union, a wireless channel complying with LTE (Long Term Evolution) formulated by the 3GPP (Third Generation Partnership Project), or a wireless channel using an IEEE (Institute of Electrical and Electronics Engineers) 802.11 standard, and
the second wireless channel is a wireless channel satisfying a requirement for URLLC (Ultra Reliable Low Latency Communication) in a wireless communication system satisfying a provision IMT-2020 specified by the International Telecommunication Union.

15. An information processing method comprising:
acquiring error information transmitted, via a second wireless channel, from a reception apparatus that receives encoded data of a video transmitted via a first wireless channel, the second wireless channel enabling transmission involving lower latency than the first wireless channel; and
controlling encoding of the video on a basis of the error information acquired.

16. An information processing apparatus comprising:
a data reception section that receives encoded data of a video transmitted via a first wireless channel; and
an error information transmission section that transmits error information indicating an error related to the encoded data received by the data reception section, to a transmission source of the encoded data via a second wireless channel enabling transmission involving lower latency than the first wireless channel.

17. The information processing apparatus according to claim 16, further comprising:
a reception error detection section that detects a reception error in reception of the encoded data by the data reception section, wherein
the error information includes information indicating the reception error detected by the reception error detection section.

18. The information processing apparatus according to claim 16, wherein
the error information includes information indicating a decoding error related to decoding of the encoded data received by the data reception section.

19. The information processing apparatus according to claim 18, further comprising:
a decoding section that decodes the encoded data received by the data reception section, wherein
the error information transmission section acquires information indicating the decoding error which information is fed from the decoding section, and transmits the error information including the information indicating the decoding error.

20. An information processing method comprising:
receiving encoded data of a video transmitted via a first wireless channel; and
transmitting error information indicating an error related to the encoded data, to a transmission source of the encoded data via a second wireless channel enabling transmission involving lower latency than the first wireless channel.
